(19) United States
(12) Patent Application Publication
(10) Pub. No.: US 2022/0016782 A1
(43) Pub. Date: Jan. 20, 2022

(54) RADIO-FREQUENCY SYSTEMS AND METHODS FOR CO-LOCALIZATION OF MULTIPLE DEVICES AND/OR PEOPLE

(71) Applicant: Humatics Corporation, Waltham, MA (US)

(72) Inventors: Matthew Carey, Watertown, MA (US); Gregory L. Charvat, Guilford, CT (US); Devon Reed Clark, Boston, MA (US); Joseph Paul Gauthier, Wayland, MA (US); James Campbell Kinsey, Brookline, MA (US); David A. Mindell, Cambridge, MA (US); Eben Christopher Rauhut, Watertown, MA (US)

(21) Appl. No.: 17/380,856

(22) Filed: Jul. 20, 2021

Related U.S. Application Data
(60) Provisional application No. 63/054,012, filed on Jul. 20, 2020.

(51) Int. Cl. B25J 9/16; H04B 17/27

(52) U.S. Cl. CPC B25J 9/1694; B25J 9/1602; H04B 17/27; B25J 9/1674; B25J 9/162

(57) ABSTRACT

Systems and methods for facilitating interactions between a robotic arm and a movable platform using radio frequency (RF) co-localization are provided. The systems include target devices; an interrogator system comprising RF antennas, each of the RF antennas configured to transmit RF signals to the target devices and/or receive RF signals from the target devices; and a controller. The controller is configured to control at least one of the RF antennas to transmit one or more first RF signals to a target device coupled to a movable platform; control at least some of the RF antennas to receive second RF signals from at least the target device; determine a position of the movable platform using the received second RF signals; and determine, using the position of the movable platform, a target position to which to move an end effector of a robotic arm in order to perform a task.

### CROSS-REFERENCE TO RELATED APPLICATIONS

This application claims priority under 35 U.S.C. § 119(e) to U.S. Provisional Patent Application Ser. No. 63/054,012, titled “Systems and Methods for Dynamic Colocation,” filed on Jul. 20, 2020, which is incorporated by reference in its entirety herein.

### BACKGROUND

Industrial environments, such as manufacturing facilities, warehouses, fulfillment centers, etc., typically have a mix of personnel, machinery, and equipment working among and in combination with each other. Automated equipment and machinery, human-controlled equipment and machinery, and human personnel may all move about independently of one other and may pose risks to one other or may not perform their functions in an efficient or coordinated manner.

### SUMMARY

Some embodiments are directed to a radio-frequency (RF) co-localization system. The system comprises: a plurality of target devices, each of the plurality of target devices being configured to transmit and receive radio-frequency (RF) signals, the plurality of target devices comprising: at least a first target device for coupling to a movable platform configured to support an object with respect to which a robotic arm is to perform a task; an interrogator system comprising a plurality of RF antennas, each of the plurality of RF antennas being configured to transmit RF signals to the plurality of target devices and/or receive RF signals from the plurality of target devices; and a controller. The controller is configured to, when at least the first target device is coupled to the movable platform: control at least one of the plurality of RF antennas to transmit one or more first RF signals to at least the first target device; control at least some of the plurality of RF antennas to receive second RF signals from at least the first target device; determine a position of the movable platform using the received second RF signals; and determine, using the position of the movable platform, a target position to which to move an end effector of the robotic arm in order to perform the task with respect to the object.

Some embodiments are directed to a method for performing RF co-localization. The method is performed by a controller part of a system, the system comprising: (i) the controller, (ii) a plurality of target devices comprising at least a first target device for coupling to a movable platform configured to support an object with respect to which a robotic arm is to perform a task, and (iii) an interrogator system comprising a plurality of RF antennas, each of the plurality of RF antennas being configured to transmit RF signals to the plurality of target devices and/or receive RF signals from the plurality of target devices. The method comprises: when at least the first target device is coupled to the movable platform, using the controller to perform: controlling at least one of the plurality of RF antennas to transmit one or more first RF signals to at least the first target device; controlling at least some of the plurality of RF antennas to receive second RF signals from at least the first target device; determining a position of the movable platform using the received second RF signals; and determining, using the position of the movable platform, a target position to which to move an end effector of the robotic arm in order to perform the task with respect to the object.

In some embodiments, at least the first target device is configured to generate and transmit the second RF signals in response to receiving the one or more first RF signals from the interrogator system.

In some embodiments, determining the position of the movable platform comprises determining a position of at least the first target device using the received second RF signals.

In some embodiments, determining the position of at least the first target device using the received second RF signals comprises: determining, using the received second RF signals, distances between the at least some of the plurality of RF antennas, distances between the at least some of the plurality of antennas and at least the first target device; and determining the position of at least the first target device using the determined distances and trilateration.

In some embodiments, at least the first target device comprises two target devices for coupling to the movable platform, and determining the position of the movable platform comprises determining positions of each of the two target devices within a common reference frame associated with the interrogator system, and determining the target position comprises: determining, using the positions of the two target devices, a first transformation between a reference frame associated with the movable platform and the common reference frame associated with the interrogator system; determining a position of the object within the common reference frame associated with the interrogator system using the first transformation; and determining the target position to which to move the end effector of the robotic arm using the position of the object.

In some embodiments, determining the first transformation comprises using a Kabsch algorithm.

In some embodiments, the movable platform includes one or more fixtures configured to affix the object to the movable platform at a known position with respect to the reference frame associated with the movable platform.

In some embodiments, at least the first target device comprises two target devices for coupling to the movable platform, and determining the position of the movable platform comprises: determining, using the received second RF signals, a position of each of the two target devices coupled to the movable platform; and determining the position of the movable platform using the positions of each of the two target devices.

In some embodiments, the plurality of target devices further comprises at least a second target device for coupling to the robotic arm or a robot platform that supports the robotic arm; and the controller is further configured to, when at least the second target device is coupled to the robotic arm or the robot platform: control the at least some of the plurality of RF antennas to receive third RF signals from at least the second target device, wherein at least the second target device is configured to generate and transmit the third RF signals in response to receiving the first RF signals from the interrogator system, determine a position of at least the second target device using the received third RF signals, and determine, using the position of at least the second target device, a current position of the end effector of the robotic arm within the common reference frame.

In some embodiments, determining the position of at least the second target device comprises determining the position of at least the second target device in the common reference frame associated with the interrogator system.

In some embodiments, the controller is further configured to determine, using the position of at least the second target device, a second transformation between a robot platform reference frame and the common reference frame associated with the interrogator system.

In some embodiments, determining the second transformation comprises: moving the end effector to at least three different non-collinear positions; determining the at least three positions within the common reference frame by using the interrogator system; determining the at least three positions within the robot platform reference frame by accessing information indicative of the at least three positions within the robot platform reference frame; and determining the second transformation by determining a homogeneous transformation matrix using the at least three positions within the common reference frame and using the at least three positions within the robot platform reference frame.

In some embodiments, the controller is further configured to determine, using the current position of the end effector within the common reference frame, the target position of the end effector within the common reference frame, and the second transformation, a travel vector for the end effector, the travel vector being between a current position of the end effector within the robot platform reference frame and a target position of the end effector within the robot platform reference frame.

In some embodiments, at least the second target device comprises a target device for coupling to the end effector, and determining the current position of the end effector comprises determining, using the received third RF signals, a position of the target device coupled to the end effector within the common reference frame associated with the interrogator system.

In some embodiments, at least the second target device comprises two target devices for coupling to the robot platform, and determining the current position of the end effector comprises: determining, using the received third RF signals, positions of the two target devices to obtain target device positions; determining, using the target device positions, a third transformation between a robot platform reference frame and a common reference frame associated with the interrogator system; determining a current position of the end effector within the robot platform reference frame by accessing information indicative of the position of the end effector within the robot platform reference frame; and applying the third transformation to the determined current position of the end effector within the robot platform reference frame to determine a current position of the end effector within the common reference frame.

In some embodiments, accessing information indicative of the position of the end effector within the robot platform reference frame comprises accessing the information via an application programming interface (API) of the robotic arm.

In some embodiments, the controller is further configured to generate a command to cause the robotic arm to move the end effector to the target position in order to perform the task with respect to the object. In some embodiments, the task comprises picking up the object from the movable platform or placing the object on the movable platform. In some embodiments, the task comprises applying a tool to alter an aspect of the object. In some embodiments, the task comprises using a sensing device to determine information about the object.

In some embodiments, determining the target position comprises determining the target position while the movable platform is in motion. In some embodiments, determining the target position while the movable platform is in motion comprises iteratively performing acts of: (A) determining, using the second RF signals, the position of the movable platform and the current position of the end effector within the common reference frame; (B) determining, using the first transformation and the position of the movable platform, the position of the object within the common reference frame; (C) determining, using the position of the object, the target position within the common reference frame; (D) determining, using the current position of the end effector within the common reference frame, the target position of the end effector within the common reference frame, and the second transformation, a travel vector for the end effector, the travel vector being between a current position of the end effector within the robot platform reference frame and a target position of the end effector within the robot platform reference frame; and (E) generating a command to cause the robotic arm to move to the target position.

In some embodiments, the controller is further configured to: determine a current position of the end effector of the robotic arm using information obtained from the robotic arm and a known transformation between a common reference frame associated with the interrogator system and a robot platform reference frame.

Some embodiments are directed to an RF co-localization system. The system comprises: a plurality of target devices, each of the plurality of target devices configured to transmit and receive radio-frequency (RF) signals, the plurality of target devices comprising: at least a first target device for coupling to a person; and at least a second target device for coupling to machinery; an interrogator system comprising a plurality of RF antennas, each of the plurality of RF antennas being configured to transmit RF signals to the plurality of target devices and/or receive RF signals from the plurality of target devices; and a controller. The controller is configured to, when at least the first target device is coupled to the person and at least the second target device is coupled to the machinery: control at least one of the plurality of RF antennas to transmit first RF signals; control at least some of the plurality of RF antennas to receive second RF signals from at least the first target device and at least the second target device; determine a first position of the person using the received second RF signals; determine a second position of the machinery using the received second RF signals; and determine whether the person is positioned within an operating volume of the machinery using the first position and the second position.

Some embodiments are directed to a method for performing RF co-localization. The method is performed by a controller part of a system, the system comprising: (i) the controller, (ii) a plurality of target devices comprising: at least a first target device for coupling to a person; and at least a second target device for coupling to machinery; and (iii) an interrogator system comprising a plurality of RF antennas, each of the plurality of RF antennas being configured to transmit RF signals to the plurality of target devices and/or receive RF signals from the plurality of target devices. The method further comprises: when at least the first target device is coupled to the person and at least the second target device is coupled to the machinery, using the controller to perform: controlling at least one of the plurality of RF antennas to transmit first RF signals; controlling at least some of the plurality of RF antennas to receive second RF signals from at least the first target device and at least the second target device; determining a first position of the person using the received second RF signals; determining a second position of the machinery using the received second RF signals; and determining whether the person is positioned within an operating volume of the machinery using the first position and the second position.

In some embodiments, the controller is configured to determine the operating volume of the machinery using locations of target devices positioned at corners of the operating volume.

In some embodiments, determining whether the person is positioned within the operating volume comprises: determining an operating volume of the person around the first position; and determining whether the operating volume of the person overlaps with the operating volume of the machinery.

In some embodiments, the controller is further configured to, after determining that the person is positioned within the operating volume of the machinery: cause at least one alert to be generated. In some embodiments, the alert is a visual alert, an audible alert, or a tactile alert.

In some embodiments, the controller is further configured to, after determining that the person is positioned within the operating volume of the machinery: generate a command to cause the machinery to stop or slow operation.

### BRIEF DESCRIPTION OF THE DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A shows a schematic diagram of a system 100 that may be used to implement radio frequency (RF) co-localization techniques, in accordance with some embodiments of the technology described herein.

FIG. 1B shows illustrative components of an interrogator device and a target device, which are part of the system 100 shown in FIG. 1A, in accordance with some embodiments of the technology described herein.

FIG. 1C shows a schematic diagram of a system 150 that may be used to implement RF co-localization techniques, in accordance with some embodiments of the technology described herein.

FIG. 2 shows an example of an RF co-localization system 200 configured to use RF localization techniques to facilitate interactions between a robotic arm and a movable platform, the robotic arm having a target device coupled to the end effector, in accordance with some embodiments of the technology described herein.

FIG. 3 shows a schematic diagram illustrating an example of device positions and reference frames of RF co-localization system 200, in accordance with some embodiments of the technology described herein.

FIG. 4 shows an example of an RF co-localization system 400 configured to use RF localization techniques to facilitate interactions between a robotic arm and a movable platform, the robotic arm having no target devices coupled to it, in accordance with some embodiments of the technology described herein.

FIG. 5 shows a schematic diagram illustrating an example of device positions and reference frames of system 400, in accordance with some embodiments of the technology described herein.

FIG. 6 shows an example of an RF co-localization system 600 configured to use RF localization techniques to facilitate interactions between a robotic arm and a movable platform, the robotic arm having target devices coupled to a robot platform, in accordance with some embodiments of the technology described herein.

FIG. 7 shows a schematic diagram illustrating an example of device positions and reference frames of system 600, in accordance with some embodiments of the technology described herein.

FIGS. 8A-8F show a sequence of images of a robotic arm interacting with an object supported by a movable platform while the movable platform is in motion, in accordance with some embodiments of the technology described herein.

FIG. 9 shows an example of an RF co-localization system 900 configured to use RF localization techniques to facilitate interactions among robotic arms, in accordance with some embodiments of the technology described herein.

FIG. 10 is a flowchart of an illustrative process 1000 for determining the target location of an end effector of a robotic arm, in accordance with some embodiments of the technology described herein.

FIG. 11 shows an example of an RF co-localization system 1100 configured to determine whether a person has entered an operating volume associated with machinery, in accordance with some embodiments of the technology described herein.

FIG. 12 is a flowchart of an illustrative process 1200 for determining whether a person has entered an operating volume associated with machinery, in accordance with some embodiments of the technology described herein.

FIG. 13 shows an example of an RF co-localization system 1300 configured to facilitate operation of a robotic arm and a movable platform in the same environment, the environment including the presence of people, in accordance with some embodiments of the technology described herein.

FIG. 14 is a flowchart of an illustrative process 1400 for determining distances between interrogator devices that are part of an interrogator system and a target device, in accordance with some embodiments of the technology described herein.

### DETAILED DESCRIPTION

Determining the position of an object (referred to herein as “localization”) has an array of applications in a number of fields. For example, the ability to locate and/or track an object at very small scales (e.g., at high resolutions) facilitates advancement of numerous applications, and has widespread applicability to a number of different fields. For example, the ability to accurately and precisely determine and track the position (e.g., in two dimensions, three dimensions, or according to the six degrees of freedom (6DOF) of the object including the rotational angles of yaw, pitch, and roll) of an object in real-time has numerous benefits in environments (e.g., industrial settings such as factories, warehouses, manufacturing facilities, etc.) where human personnel and machinery (e.g., robotics and/or other industrial machinery) work and move about independently. The performance of certain tasks in such environments (e.g., coordinating cooperation among multiple pieces of automated machinery, ensuring that personnel are at a safe distance from operated machinery) requires certain accuracy and precision that is not currently available using conventional localization techniques, particularly when machinery (e.g., automated guided vehicles (AGVs)) and/or personnel is moving through the environment.

Conventional localization techniques have substantial drawbacks and are inadequate for many (or most) of these applications and/or perform unsatisfactorily in all but very limited circumstances or controlled environments. In particular, conventional localization techniques suffer from one or more drawbacks that significantly limit their use and/or applicability, including insufficient accuracy and/or precision, low signal-to-noise (SNR) ratio, relatively lengthy refresh rates, susceptibility to background clutter, high cost, and large size. As a result, conventional localization techniques generally have narrow and limited application.

For example, some conventional localization techniques use cameras and/or lasers, both of which can be limited in range due to lens geometry. Additionally, such techniques typically do not perform well in environments that are dusty, dirty, and/or have varying lighting conditions, have trouble detecting overly-shiny and non-reflective components, can have limited fields-of-view, and can be cost-prohibitive to install. As another example, some conventional localization systems may rely on grid-based simultaneous localization and mapping (SLAM) techniques. However, the performance of these systems typically degrades with changes in the environment (e.g., movement of pieces of equipment, etc.).

The inventors have developed a radio frequency (RF) based co-localization system for precise and accurate localization of pieces of machinery and/or people in a shared environment, such as an industrial environment. In some embodiments, the RF co-localization system operates by using an RF interrogator system and multiple target devices (e.g., transponders) to precisely and accurately estimate positions of machinery and/or personnel in a common reference frame, which enables the orchestration of multiple tasks in a way that permits precise, safe interactions among personnel and machinery and/or among two or more pieces of machinery. For example, in some embodiments, an interrogator system may be installed in an environment (e.g., on a ceiling of a factory or warehouse), target devices may be coupled to machinery and/or personnel in the environment (e.g., on AGVs, robotic arms, conveyor belts, and/or people working in the environment), and the system may be configured to use the interrogator system and the target devices (e.g., by causing the interrogator system to send RF signals to and receive responsive RF signals from the target devices) to determine the positions of the target devices in a common reference frame (e.g., the reference frame associated with the interrogator system). The positions so determined provide information about the relative positioning of machinery and/or personnel in the environment (“co-localizing” them) and, in turn, can be used to control machinery (e.g., command a robotic arm to move its end effector to a target position, command an AGV to slow down or stop, turn off machinery for safety if a worker is within an operating volume of the machinery, generate an alert if the worker is within the operating volume of the machinery, etc.) or perform any other suitable tasks(s).

The systems and techniques described herein allow for the localization of target devices at a distance of up to approximately 2-10 meters, 2-20 meters, 5-40 meters, 20-40 (e.g., 30) meters within a conical field of view of the interrogator system of ±10, 20, 30, 40, 50, or 60 degrees. For example, in some embodiments, localization may be performed within a field of view of ±40 degrees at a range between 5-10 meters, within a field of view of ±40 degrees at a range of approximately 6 meters, within a field of view of ±40 degrees at a range of approximately 9 meters, within a field of view of ±40 degrees at a range from 20 to 40 meters, within a field of view of ±40 degrees at a range of approximately 30 meters. In some embodiments, the systems and techniques described herein allow for the localization of target devices at a sub-millimeter resolution (e.g., within approximately 200 microns, within approximately 500 microns, within approximately 800 microns). In some embodiments, the systems and techniques described herein allow for the localization of target devices at approximately a millimeter resolution. In some embodiments, the systems and techniques described herein allow for the localization of target devices at a resolution within a range from approximately a millimeter to approximately seven millimeters. For example, in some embodiments, localization may be performed within a field of view of ±40 at a range of approximately 30 meters with a resolution of less than approximately five millimeters.

The RF co-localization system developed by the inventors enables the safe and accurate performance of numerous tasks. For example, as described herein, the RF co-localization system developed by the inventors enables coordination between a movable platform (e.g., an AGV, a conveyor belt, etc.) configured to support an object and a robotic arm so that the robotic arm may perform one or more tasks with respect to the object. Non-limiting examples of such tasks include: picking up the object from the movable platform (e.g., by using a gripper on the robotic arm), placing an object on the movable platform (e.g., also by using a gripper), applying a tool (e.g., a drill, screwdriver, welder, etc.) on the robotic arm to the object, and sensing information about the object (e.g., using a sensor on the robotic arm). The techniques developed by the inventors and described herein allow for coordination between a movable platform and a robotic arm not only in situations where the movable platform is not moving relative to the robotic arm (e.g., an AGV pulls up near a robotic arm and stops before the robotic arm performs any task with respect to the object), but also in situations where the movable platform moves relative to the robotic arm during performance of the task (e.g., an AGV carrying an object moves past a robotic arm while the robotic arm performs a task on the moving object, a conveyor belt carrying an object moves past a robotic arm while the robotic arm performs a task on the moving object).

As another example, as described herein, the RF co-localization system developed by the inventors enables coordination between personnel and machinery operating in the same environment. For example, the RF co-localization system developed by the inventors may be used to reduce workplace accidents by stopping or slowing down operation of heavy machinery (e.g., a robotic arm, a press, etc.) when a person gets too close to the operating volume of the machinery, and/or by generating an alert (e.g., audible, visual, or tactile alert) to warn the personnel that they are getting too close to (or are impermissibly within) the operating volume of the machinery.

Accordingly, some embodiments provide for an RF co-localization system. The system includes target devices configured to transmit and receive RF signals. The target devices may include a target device for coupling to a movable platform. The movable platform may be configured to support one or more objects with respect to which a robotic arm is to perform a task. In some embodiments, the movable platform may include fixtures (e.g., pegs, holes, clamps, or other securing devices) configured to affix the object to the movable platform at a known position (e.g., at known locations and/or orientations relative to the target device coupled to the movable platform) within a reference frame (e.g., a coordinate system) associated with the movable platform.

In some embodiments, the system also includes an interrogator system including RF antennas. The RF antennas may be configured to transmit RF signals to the target devices and/or receive RF signals from the target devices. In some embodiments, the interrogator system may include RF antennas configured to transmit RF signals and other RF antennas configured to receive RF signals from the target devices, whereas in some embodiments the interrogator system may include RF antennas configured to transmit and receive RF signals. In some embodiments, the target devices may be configured to generate and transmit RF signals in response to receiving RF signals from the interrogator system.

In some embodiments, the system includes a controller. The controller may be configured to, when the target device is coupled to the movable platform, control at least one of the RF antennas to transmit first RF signals and to control at least some of the RF antennas to receive second RF signals from the target device coupled to the movable platform. The controller may also be configured to determine a position of the movable platform using the received second RF signals. For example, the controller may determine the position of the movable platform by determining a position of the target device coupled to the movable platform using the received second RF signals. The controller may determine the position of the target device coupled to the movable platform using, for example, trilateration techniques.

In some embodiments, there may be two or more target devices for coupling to the movable platform. In such embodiments, determining the position of the movable platform may be performed by determining, using the received second RF signals from the two or more target devices, a position of each of the two or more target devices coupled to the movable platform. Determining the position of the movable platform may then be performed using the positions of each of the two or more target devices. In some embodiments, determining the position of the movable platform may comprise determining positions of each of the two or more target devices in a common reference frame (e.g., a common coordinate system) associated with the interrogator system.

In some embodiments, the controller may also be configured to determine, using the position of the movable platform, a target position to which to move an end effector of a robotic arm in order to perform a task with respect to the object supported by the movable platform. Determining the target position may include determining, using the positions of the target device(s) coupled to the movable platform, a first transformation between a reference frame associated with the movable platform and the common reference frame associated with the interrogator system. For example, the first transformation may be determined using any suitable algorithm such as, but not limited to, the Kabsch algorithm. The position of the object within the common reference frame associated with the interrogator system may then be determined using the first transformation, and the target position to which to move the end effector of the robotic arm may be determined using the position of the object within the common reference frame.

In some embodiments, the target devices may also include a target device for coupling to the robotic arm or to a robot platform that supports the robotic arm. In some embodiments, the controller may be configured to, when the target device is coupled to the robotic arm or the robot platform, control some of the RF antennas of the interrogator system to receive third RF signals from the target device coupled to the robotic arm or the robot platform, where the target device coupled to the robotic arm or the robot platform is configured to generate and transmit the third RF signals in response to receiving the first RF signals from the interrogator system. The controller may also be configured to determine a position of the target device coupled to the robotic arm or the robot platform using the received third RF signals, and to determine, using the position of the target device coupled to the robotic arm or robot platform, a current position of the end effector of the robotic arm within the common reference frame of the interrogator system. In some embodiments, the controller may be configured to determine the position of the target device coupled to the robotic arm or to the robot platform within the common reference frame associated with the interrogator system.

In some embodiments, the controller may be configured to determine, using the position of the target device coupled to the robotic arm or the robot platform, a second transformation between a robot platform reference frame and the common reference frame associated with the interrogator system. For example, the second transformation may be determined using any suitable algorithm such as, but not limited to, the Kabsch algorithm. The controller may also be configured to determine, using (1) the current position of the end effector within the common reference frame, (2) the target position of the end effector within the common reference frame, and (3) the second transformation, a travel vector for the end effector. The travel vector may be between a current position of the end effector within the robot platform reference frame and a target position of the end effector within the robot platform reference frame (e.g., such that it specifies a direction of movement for the robotic arm).

In some embodiments, determining the second transformation may include moving the end effector of the robotic arm to at least three positions in space. The at least three positions may be non-collinear positions. For each position of the at least three positions, the position of the end effector may be determined within the common reference frame by using the interrogator system. Each position of the at least three positions may also be determined within the robot platform reference frame by accessing information from the robotic arm. The information may be indicative of the position within the robot platform reference frame. The second transformation may then be determined by determining a homogeneous transformation matrix (e.g., using the Kabsch algorithm) using the at least three positions within the common reference frame and using the at least three positions within the robot platform reference frame.

In some embodiments, the target device coupled to the robotic arm or to the robot platform may include a target device coupled to the end effector of the robotic arm. In such embodiments, determining the current position of the end effector may be performed by determining, using the received third RF signals from the target device coupled to the end effector, a position of the target device coupled to the end effector within the common reference frame associated with the interrogator system.

In some embodiments, the target device coupled to the robotic arm or to the robot platform may include two target devices coupled to the robot platform. In such embodiments, determining the current position of the end effector may be performed by determining, using the received third RF signals from the two target devices coupled to the robot platform, positions of the two target devices to obtain target device positions. A third transformation may then be determined using the target device positions. The third transformation may be between a robot platform reference frame and a common reference frame associated with the interrogator system. The current position of the end effector within the robot platform reference frame may be determined by accessing information indicative of the position of the end effector within the robot platform reference frame. For example, the information may be accessed via an application programming interface (API) of the robotic arm. The current position of the end effector within the common reference frame may then be determined by applying the third transformation to the current position of the end effector within the robot platform reference frame.

In some embodiments, there may be no target device coupled to the robotic arm during operation of the system. In such embodiments, a known transformation between the common reference frame associated with the interrogator system and the robot platform reference frame may be determined. For example, one or more target devices (e.g., transponders) may be placed on the robotic arm and/or robot platform so that the known transformation can be determined using the interrogator system. During operation, the current position of the end effector may be determined using information obtained from the robotic arm, the information indicative of a position of the end effector within the robot platform reference frame, and the known transformation.

In some embodiments, the controller may also be configured to generate a command to cause the robotic arm to move the end effector to the target position. The command may also cause the robotic arm to perform a task with respect to the object supported by the movable platform. In some embodiments, the task may include picking up the object from the movable platform or placing the object on the movable platform. In some embodiments, the task may include applying a tool (e.g., a drill, a screwdriver, a welder, etc.) to alter an aspect of the object. In some embodiments, the task may include using a sensing device (e.g., a measuring device, an optical sensor, a thermal sensor, etc.) to determine information about the object.

In some embodiments, determining the target position may include determining the target position while the movable platform is in motion. In such embodiments, determining the target position may be performed iteratively (e.g., by repeatedly controlling the interrogator system to communicate with the target devices coupled to the movable platform, robotic arm, and/or robot platform) to cause the robotic arm to track the object and the movable platform as the movable platform moves.

In some embodiments, determining the target position while the movable platform is in motion may include performing a series of steps iteratively. The determination may include, at a first time, (1) determining, using the second RF signals received from the target devices, the position of the movable platform and the current position of the end effector within the common reference frame, (2) determining, using a transformation between a reference frame associated with the movable platform and the common reference frame and the position of the movable platform, the position of the object within the common reference frame, (3) determining, using the position of the object in the common reference frame, the target position of the end effector within the common reference frame, (4) determining, using the current position of the end effector within the common reference frame, the target position of the end effector within the common reference frame, and a transformation between a reference frame associated with the robot platform and the common reference frame, a travel vector for the end effector, the travel vector being between a current position of the end effector within the robot platform reference frame and a target position of the end effector within the robot platform reference frame, and (5) generating a command to cause the robotic arm to move to the target position. Thereafter, in some embodiments, the interrogator system may iteratively perform (1)-(5) until it is determined that the end effector of the robotic arm is following the object such that the robotic arm can perform the task with respect to the object. For example, a Kalman filter may be used to determine whether the end effector is closely tracking the object by determining whether an estimated error is below a threshold value. As another example, a proportional-integral-derivative (PID) method may be sued to determine whether the end effector is closely tracking the object.

In some embodiments, the system may be configured for performing RF co-localization of a person with respect to machinery and includes target devices and an interrogator system. In such embodiments, the target devices may include a target device for coupling to a person and a target device for coupling to machinery. The machinery may include, as non-limiting examples, robotic arms, AGVs, machining equipment (e.g., drills, lathes, computer numerical control (CNC) machines, etc.), equipment associated with a production line, equipment associated with a warehouse and fulfillment facility, hydraulic equipment, any other suitable industrial equipment with moving parts and/or automated equipment that could be harmful to humans in its operation.

In some embodiments, the system may include a controller. The controller may be configured to, when the target devices are coupled to the person and the machinery, control at least one of the RF antennas of the interrogator system to transmit first RF signals and to control some of the RF antennas to receive second RF signals from the target devices coupled to the person and the machinery. In some embodiments, the controller may be configured to determine a first position of the person using the received second RF signals and to determine a second position of the machinery using the received second RF signals.

In some embodiments, the controller may further be configured to determine whether the person is positioned within an operating volume of the machinery. The operating volume of the machinery is a defined volume around the machinery within which a person could experience harm if the machinery was in operation while the person is present. In some embodiments, the operating volume of the machinery may be defined. For example, the controller may be configured to determine the operating volume of the machinery using locations of target devices that are placed at corners of the three-dimensional operating volume of the machinery. Alternatively, the target devices may be placed at corners of a two-dimensional area around the machinery, and the controller may be configured to define the three-dimensional operating volume of the machinery based on the two-dimensional area defined by the target devices (e.g., by “extruding” the two-dimensional area).

In some embodiments, the controller may be configured to determine whether the person is positioned within the operating volume of the machinery using the first position and the second position of the target devices. For example, in some embodiments, the controller may be configured to determine whether the person is positioned within the operating volume by determining an operating volume of the person around the first position. For example, the operating volume of the person may be defined as a maximum region within which the person is expected to interact (e.g., within an average arm reach about the first position). The controller may be configured to then determine whether the operating volume of the person overlaps with the operating volume of the machinery.

In some embodiments, the controller may further be configured to, after determining that the person is positioned within the operating volume of the machinery, generate a command to mitigate harm that may affect the person. For example, the controller may be configured to generate a command to cause an alert to be generated. The alert may be a visual alert, an audible alert, or a tactile alert. In some embodiments, the controller may be configured to generate a command to stop or slow operation of the machinery.

As used herein, a position of an item (e.g., a target device, an end effector of a robotic arm, an object, a movable platform, etc.) refers to information describing the position and/or orientation of the item in any suitable coordinate system of any dimension. For example, a position of an item may refer to a two-dimensional (2D) position of the item in any suitable 2D coordinate system (e.g., Euclidean, polar, etc.), a three-dimensional (3D) position of the item in any suitable 3D coordinate system (e.g., Euclidean, spherical, cylindrical, etc.), a six-dimensional (6D) position of the item in any suitable 6D coordinate system (e.g., three dimensions for position and three dimensions for orientation such as, for example, yaw, pitch, and roll angles).

A robotic arm may be any suitable type of mechanical arm comprising one or more links connected by joints. A joint may allow rotational motion and/or translational displacement. The links of the arm may be considered to form a chain and the terminus of the chain may be termed an “end effector.” A robotic arm may have any suitable number of links (e.g., 1, 2, 3, 4, 5, etc.). A robotic arm may have any suitable number of joints (0, 1, 2, 3, 4, 5, etc.). For example, a robotic arm may be a multi-axis articulated robot having multiple rotary joints.

An end effector may be any suitable terminus of a robotic arm. An end effector may comprise a gripper, a tool, and/or a sensing device. A gripper may be of any suitable type (e.g., jaws or fingers to grasp an object, pins/needles that pierce the object, a gripper operating by attracting an object through vacuum, magnetic, electric, or other techniques). A tool may be a drill, screwdriver, welder, or any other suitable type of tool configured to perform an action on an object and/or alter an aspect of the object. A sensing device may be an optical sensor, an electrical sensor, a magnetic sensor, a thermal sensor, or any other suitable sensing device.

A movable platform may be any surface that may be moved throughout an environment and that is suitable for supporting objects thereon. For example, a movable platform may be a platform that may be moved manually within an environment (e.g., a cart or table having wheels). As another example, a movable platform may be an automatically-positioned platform configured to move throughout the environment autonomously (e.g., an AGV) and/or to transport its conveying medium throughout the environment (e.g., a conveyor belt).

Following below are more detailed descriptions of various concepts related to, and embodiments of, techniques for implementing RF co-localization of multiple devices and/or people. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

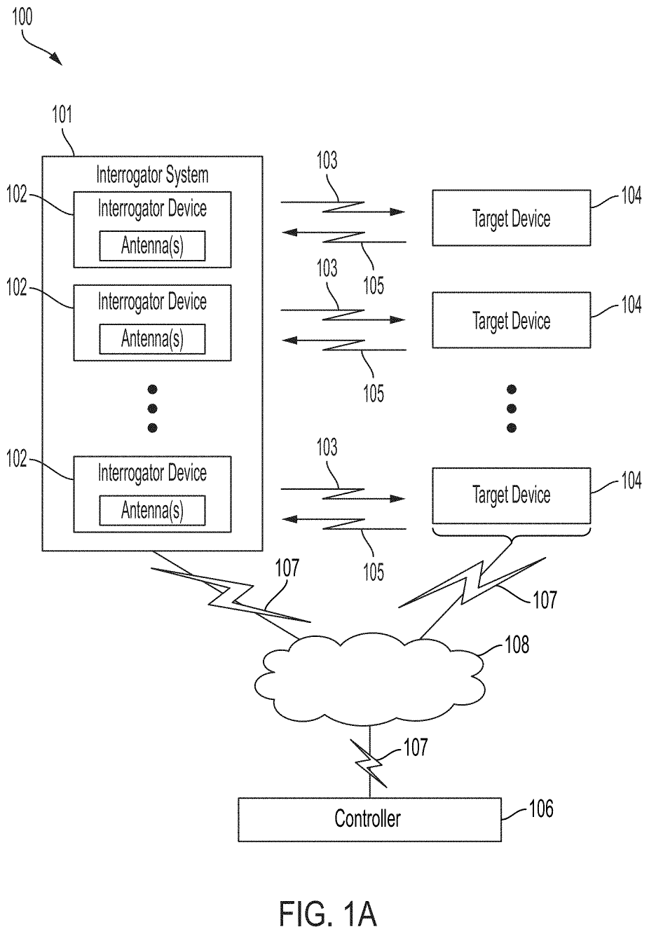

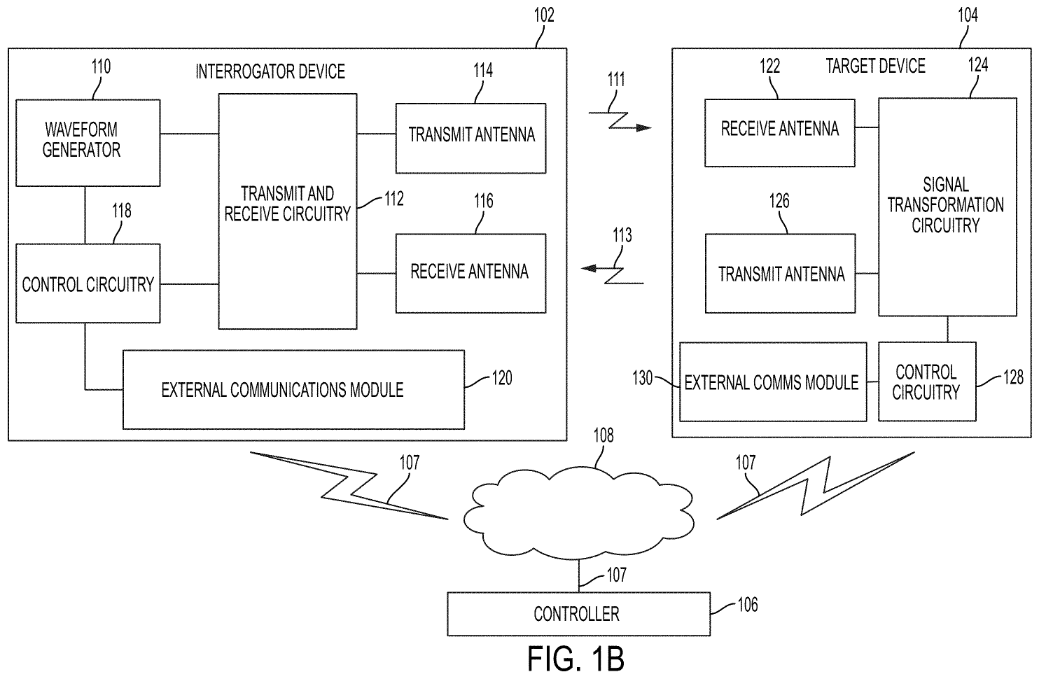

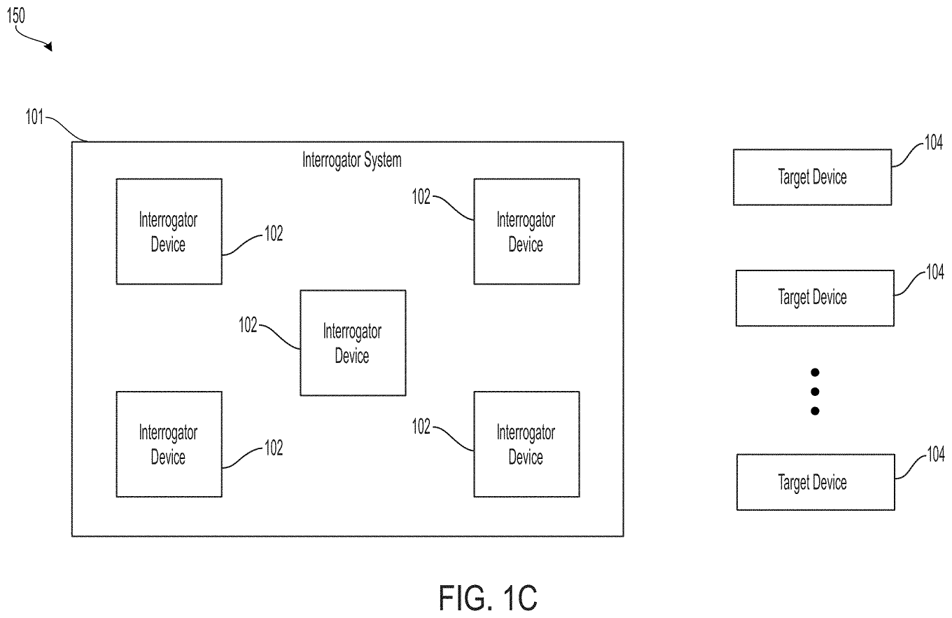

FIG. 1A shows a schematic diagram of a system 100 that may be used to implement radio frequency (RF) localization techniques, in accordance with some embodiments of the technology described herein. System 100 comprises an interrogator system 101 including interrogator devices 102 including antenna(s). One or more of the interrogator devices 102 are configured to transmit an RF signal 103. System 100 also comprises one or more target devices 104 configured to receive RF signals 103 and, in response, transmit RF signals 105. One or more of the interrogator devices 102 are configured to receive RF signals 105 that are then used to determine distances between the interrogator system 101 and target devices 104. The computed distances may be used to determine the position of one or more target devices 104. It should be appreciated that while multiple target devices 104 are illustrated in FIG. 1A, a single target device 104 may be utilized. More generally, it should be appreciated that any number of interrogator systems 101, any number of interrogator devices 102, and any number of target devices 104 may be used, as the aspects of the technology described herein are not limited in this respect.

System 100 may also include a controller 106 configured to communicate with interrogator system 101 and target devices 104 via communication channel 108. The communication channel 108 may include a network, device-to-device communication channels, and/or any other suitable means of communication. Controller 106 may be configured to coordinate the transmission and/or reception of RF signals 103 and 105 between desired interrogator and target devices via communication channels 107, which may be a single communication channel or include multiple communication channels. Controller 106 may also be configured to determine the position of one or more target devices 104 from information received from interrogator system 101. As discussed in further detail below, controller 106 may be implemented as a standalone controller or may be implemented in full or in part by one or more interrogator system 101 and/or target devices 104. Different exemplary configurations and implementations for system 100 are described in further detail below but are not limited to the configurations discussed herein.

Resolving the location of a target with a high degree of accuracy depends in part on receiving the RF signals transmitted by the target devices 104 with high fidelity and, in part, on the ability to distinguish the RF signals transmitted by a target device 104 from RF signals transmitted by an interrogator system 101, background clutter, and/or noise. The inventors have developed techniques for improving the signal-to-noise ratio (SNR) of the signals received by the interrogator and target devices to facilitate micro-localization of one or more target devices. As one example, the inventors recognized that by configuring the interrogator and target devices to transmit at different frequencies, localization performance can be improved. According to some embodiments, one or more interrogator systems 101 transmit first RF signals (e.g., RF signals 103) having a first center frequency and, in response to receiving the first RF signals, one or more target devices 104 transmit second RF signals (e.g., RF signals 105) having a second center frequency different from the first center frequency. In this manner, receive antennas on the one or more interrogator systems can be configured to respond to RF signals about the second center frequency, improving the ability of the interrogator systems to receive RF signals from target devices in cluttered and/or noisy environments. According to some embodiments, the second center frequency is harmonically related to the first center frequency. For example, in system 100 illustrated in FIG. 1A, a target device 104 may be configured to transform RF signals 103 and transmit RF signals 105 at a harmonic of the center frequency of the received RF signal 103. According to other embodiments, a target device transforms RF signals having a first center frequency received from an interrogator system to RF signals having second center frequency that is different from, but not harmonically related to the first center frequency. In other embodiments, a target device is configured to generate RF signals at a second center frequency different from the first center frequency, either harmonically or not harmonically related, rather than transforming RF signals received from an interrogator system.

The inventors have further recognized that changing the polarization of RF signals transmitted by interrogator and target devices, respectively, may be used to improve SNR and allow interrogator systems to receive RF signals transmitted by target devices with improved fidelity, facilitating micro-localization even in cluttered and/or noisy environments. According to some embodiments, one or more interrogator systems are configured to transmit first RF signals circularly polarized in a first rotational direction (e.g., clockwise) and, in response to receiving the first RF signals, one or more target devices are configured to transmit second RF signals circularly polarized in a second rotational direction different from the first rotational direction (e.g., counter-clockwise). A target device may be configured to transform the polarization of received RF signals or may be configured to generate RF signals circularly polarized in the second rotation direction, as aspects of the technology described herein are not limited in this respect. Exemplary techniques for transmitting RF signals, from interrogator and target devices, circularly polarized in different respective rotational directions are discussed in further detail below.

As discussed above, many conventional localization techniques suffer from low SNR and, as a result, are limited in the range in which the localization techniques can operate and/or may exhibit lengthy refresh times (e.g., the interval of time between successive computations of the location of a target) due, at least in part, to the need to repeatedly interrogate the target to build up enough signal to adequately determine the distance to the target. The inventors have developed techniques to improve SNR that substantially increase the range at which micro-localization can be performed (i.e., increase the distance between interrogator and target devices at which the system can micro-locate the target device). Referring again to the exemplary system 100 illustrated in FIG. 1A, an interrogator system 101 may be configured to transmit first RF signals 103 and receive second RF signals 105 transmitted by one or more target devices 104 in response. Accordingly, an interrogator system 101 may comprise interrogator devices 102 including a transmit antenna for transmitting the first RF signals and/or a receive antenna for receiving second RF signals. Any RF signals generated for transmission by and/or transmitted by the interrogator's transmit antenna that are also detected by the interrogator's receive antenna interfere with the ability of the receive antenna to detect RF signals being transmitted by one or more target devices. For example, any portion of an RF signal generated by an interrogator for transmission that is picked up by the interrogator's receive antenna operates as noise that decreases the SNR (or as interference decreasing the SINR, which is the signal to interference plus noise ratio), effectively drowning out the RF signals being transmitted by a target device 104 and reduces the range at which the interrogator can determine the location of the target device.

To increase the SNR, the inventors have developed a number of techniques to reduce the amount and/or impact of signal detection by the receive antenna of RF signals generated by interrogator system for transmission by and/or transmitted by the transmit antenna (or by the transmit antenna of a proximately located interrogator or target devices). As discussed above, transmitting and receiving at different center frequencies facilitate signal differentiation, but also reduces interference between transmit and receive antennas. However, receive antennas remain susceptible to detection of transmitted signals, for example, harmonics that are transmitted from the transmit antenna. The inventors have further recognized that transmitting and receiving at different circular polarizations, as discussed above, further reduces interference between transmit and receive channels. The inventors have further recognized that differentially coupling a receive antenna and/or a transmit antenna to transmit/receive circuitry of the interrogator system reduces the amount of interference between the transmit and receive channels. Similar differential coupling can be implemented at the target device for the same purpose. One or any combination of these techniques may be used to reduce interference and increase SNR.

The inventors have developed numerous techniques that provide for a robust and relatively inexpensive micro-localization system capable of being employed in a wide variety of applications. According to some embodiments, a micro-localization system using techniques described herein are capable of resolving the location of a target device with accuracy in the millimeter or sub-millimeter range in virtually any environment. In addition, using the techniques described herein, location of a target can be determined in milliseconds, a millisecond, or less, facilitating real-time tracking of targets that are rapidly moving. Techniques developed by the inventors, including chip-scale fabrication of micro-localization components, facilitate a general-purpose micro-localization system that can be manufactured at relatively low cost and high volume and that can be conveniently integrated in a variety of application level systems. These and other techniques are discussed in further detail below in connection with exemplary micro-localization systems, in accordance with some embodiments.

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

FIG. 1B shows illustrative components of an illustrative interrogator device 102 and an illustrative target device 104, which are part of the illustrative system 100 shown in FIG. 1A, in accordance with some embodiments of the technology described herein. As shown in FIG. 1B, illustrative interrogator device 102 includes waveform generator 110, transmit and receive circuitry 112, transmit antenna 114, receive antenna 116, control circuitry 118, and external communications module 120.

It should be appreciated that, in some embodiments, an interrogator device may include one or more other components in addition to or instead of the components illustrated in FIG. 1B. In some embodiments, the interrogator device 102 may include all components as depicted in FIG. 1B (e.g., including the waveform generator 110, control circuitry 118, external communications module 120, and/or transmit and receive circuitry 112). In some embodiments, the interrogator device 102 may share some or all components (e.g., the waveform generator 110, control circuitry 118, external communications module 120, and/or transmit and receive circuitry 112) with other interrogator devices included in the interrogator system to reduce circuitry duplication. Similarly, in some embodiments, a target device may include one or more other components in addition to or instead of the components illustrated in FIG. 1B.

In some embodiments, waveform generator 110 may be configured to generate RF signals to be transmitted by the interrogator device 102 using transmit antenna 114. Waveform generator 110 may be configured to generate any suitable type(s) of RF signals. In some embodiments, waveform generator 110 may be configured to generate frequency modulated RF signals, amplitude modulated RF signals, and/or phase modulated RF signals. Non-limiting examples of modulated RF signals, any one or more of which may be generated by waveform generator 110, include linear frequency modulated signals (also termed “chirps”), non-linearly frequency modulated signals, binary phase coded signals, signals modulated using one or more codes (e.g., Barker codes, bi-phase codes, minimum peak sidelobe codes, pseudo-noise (PN) sequence codes, quadri-phase codes, poly-phase codes, Costas codes, Welti codes, complementary (Golay) codes, Huffman codes, variants of Barker codes, Doppler-tolerant pulse compression signals, impulse waveforms, noise waveforms, and non-linear binary phase coded signals. Waveform generator 110 may be configured to generate continuous wave RF signals or pulsed RF signals. Waveform generator 110 may be configured to generate RF signals of any suitable duration (e.g., on the order of microseconds, milliseconds, or seconds).

In some embodiments, waveform generator 110 may be configured to generate microwave and/or millimeter wave RF signals. For example, waveform generator 110 may be configured to generate RF signals having a center frequency in a given range of microwave and/or millimeter frequencies (e.g., 4-6 GHz, 50-70 GHz). It should be appreciated that an RF signal having a particular center frequency is not limited to containing only that particular center frequency (the RF signal may have a non-zero bandwidth). For example, waveform generator 110 may be configured to generate a chirp having a center frequency of 60 GHz whose instantaneous frequency varies from a lower frequency (e.g., 59 GHz) to an upper frequency (e.g., 61 GHz). Thus, the generated chirp has a center frequency of 60 GHz and a bandwidth of 2 GHz and includes frequencies other than its center frequency.

In some embodiments, waveform generator 110 may be configured to generate RF signals using a phase locked loop. In some embodiments, the waveform generator may be triggered to generate an RF signal by control circuitry 118 and/or in any other suitable way.

In some embodiments, transmit and receive circuitry 112 may be configured to provide RF signals generated by waveform generator 110 to transmit antenna 114. Additionally, transmit and receive circuitry 112 may be configured to obtain and process RF signals received by receive antenna 116. In some embodiments, transmit and receive circuitry 112 may be configured to: (1) provide a first RF signal to the transmit antenna 114 for transmission to a target device 104 (e.g., RF signal 111); (2) obtain a responsive second RF signal received by the receive antenna 116 (e.g., RF signal 113) and generated by the target device 104 in response to the transmitted first RF signal; and (3) process the received second RF signal by mixing it (e.g., using a frequency mixer) with a transformed version of the first RF signal. The transmit and receive circuitry 112 may be configured to provide processed RF signals to control circuitry 118, which may (with or without performing further processing the RF signals obtained from transmit and receive circuitry 112) provide the RF signals to external communications module 120.

In some embodiments, each of transmit antenna 114 and receive antenna 116 may be a patch antenna, a planar spiral antenna, an antenna comprising a first linearly polarized antenna and a second linearly polarized antenna orthogonally disposed to the first linearly polarized antenna, a MEMS antenna, a dipole antenna, or any other suitable type of antenna configured to transmit or receive RF signals. Each of transmit antenna 114 and receive antenna 116 may be directional or isotropic (omnidirectional). Transmit antenna 114 and receive antenna 116 may be the same type or different types of antennas.

In some embodiments, transmit antenna 114 may be configured to radiate RF signals circularly polarized in one rotational direction (e.g., clockwise) and the receive antenna 116 may be configured to receive RF signals circularly polarized in another rotational direction (e.g., counter-clockwise). In some embodiments, transmit antenna 114 may be configured to radiate RF signals having a first center frequency (e.g., RF signal 111 transmitted to target device 104) and the receive antenna may be configured to receive RF signals having a second center frequency different from (e.g., a harmonic of) the first center frequency (e.g., RF signal 113 received from target device 104 and generated by target device 104 in response to receiving the RF signal 111).

In some embodiments, transmit antenna 114 and receive antenna 116 are physically separate antennas. In other embodiments, however, the interrogator device 102 may include a dual mode antenna configured to operate as a transmit antenna in one mode and as a receive antenna in another mode.

In some embodiments, control circuitry 118 may be configured to trigger the waveform generator 110 to generate an RF signal for transmission by the transmit antenna 114. The control circuitry 118 may trigger the waveform generator in response to a command to do so received by external communications module 120 and/or based on logic part of control circuitry 118.

In some embodiments, control circuitry 118 may be configured to receive RF signals from transmit and receive circuitry 112 and forward the received RF signals to external communications module 120 for sending to controller 106. In some embodiments, control circuitry 118 may be configured to process the RF signals received from transmit and receive circuitry 112 and forward the processed RF signals to external communications module 120. Control circuitry 118 may perform any of numerous types of processing on the received RF signals including, but not limited to, converting the received RF signals to from analog to digital (e.g., by sampling using an ADC), performing a Fourier transform to obtain a frequency-domain waveform, estimating a time of flight between the interrogator and the target device from the frequency-domain waveform, and determining an estimate of distance between the interrogator device 102 and the target device that the interrogator device 102 interrogated. The control circuitry 118 may be implemented in any suitable way and, for example, may be implemented as an application specific integrated circuit (ASIC), a field programmable gate array (FPGA), a combination of logic circuits, a microcontroller, or a microprocessor.

External communications module 120 may be of any suitable type and may be configured to communicate according to any suitable wireless protocol(s) including, for example, a Bluetooth communication protocol, an IEEE 802.15.4-based communication protocol (e.g., a “ZigBee” protocol), and/or an IEEE 802.11-based communication protocol (e.g., a “WiFi” protocol).

As shown in FIG. 1B, target device 104 includes receive antenna 122, signal transformation circuitry 124, transmit antenna 126, control circuitry 128, and external communications module 130.

In some embodiments, each of receive antenna 122 and transmit antenna 126 may be a patch antenna, a planar spiral antenna, an antenna comprising a first linearly polarized antenna and a second linearly polarized antenna orthogonally disposed to the first linearly polarized antenna, a MEMS antenna, a dipole antenna, or any other suitable type of antenna configured to receive or transmit RF signals. Each of receive antenna 122 and transmit antenna 126 may be directional or isotropic. Receive antenna 122 and transmit antenna 126 may the same type or different types of antennas. In some embodiments, receive antenna 122 and transmit antenna 126 may be separate antennas. In other embodiments, a target device may include a dual mode antenna operating as a receive antenna in one mode and as a transmit antenna in the other mode.

In some embodiments, receive antenna 122 may be configured to receive RF signals circularly polarized in one rotational direction (e.g., clockwise) and the transmit antenna 126 may be configured to transmit RF signals circularly polarized in another rotational direction (e.g., counter-clockwise).

In some embodiments, receive antenna 122 may be configured to receive RF signals having a first center frequency. The received RF signals may be transformed by signal transformation circuitry 124 to obtain transformed RF signals having a second center frequency different from (e.g., a harmonic of) the first center frequency. The transformed RF signals having the second center frequency may be transmitted by transmit antenna 126.

In some embodiments, each of the transmit and/or the receive antennas on an interrogator may be directional antennas. This may be useful in applications where some information is known about the region of space in which the target device is located (e.g., the target device is located in front of the interrogator, to the front left of the interrogator, etc.). Even if the target device is attached to a moving object (e.g., an arm of an industrial robot, a game controller), the movement of the target device may be constrained so that the target device is always within a certain region of space relative to the interrogator so that using directional antennas to focus on that region of space increases the sensitivity of the interrogator to signals generated by the target device. In turn, this increases the distance between the interrogator and target device at which the micro-localization system may operate with high accuracy. However, it should be appreciated that in some embodiments, the antennas on an interrogator may be isotropic (omnidirectional), as aspects of the technology described herein are not limited in this respect.

In some embodiments, each of the transmit and/or the receive antennas on the target device may be isotropic so that the target device may be configured to receive signals from and/or provide RF signals to an interrogator located in any location relative to the target device. This is advantageous because, in some applications of micro-localization, the target device may be moving and its relative orientation to one or more interrogators may not be known in advance. However, in some embodiments, the antennas on a target device may be directional (anisotropic), as aspects of the technology described herein are not limited in this respect.

In some embodiments, control circuitry 128 may be configured to turn the target device 104 on or off (e.g., by powering off one or more components in signal transformation circuitry 124) in response to a command to do so received via external communications module 130. The control circuitry 128 may be implemented in any suitable way and, for example, may be implemented as an application specific integrated circuit (ASIC), a field programmable gate array (FPGA), a combination of logic circuits, a microcontroller, or a microprocessor. External communications module 130 may be of any suitable type including any of the types described herein with reference to external communications module 120.

As discussed above with reference to FIG. 1A, multiple interrogator devices 102 may be utilized in order to determine a location of a target device 104. In some embodiments, at least one of the interrogator devices 102 may be configured to transmit an RF signal to a target device, at least some of the interrogator devices 102 may be configured to receive a responsive RF signal from the target device (the responsive signal may have a different polarization and/or a different center frequency from the signal that was transmitted), and process the transmitted RF signal together with the received RF signal to obtain an RF signal indicative of the distance between the interrogator device and the target device. The RF signals indicative of the distances between the interrogator devices and the target device may be processed (e.g., by the interrogators or another processor) to obtain estimates of the distances between the target device and each of the interrogators. In turn, the estimated distances may be used to determine the position of the target device in a reference frame associated with the interrogator devices.

FIG. 1C shows an illustrative system 150 that may be used to implement RF micro-localization techniques, in accordance with some embodiments of the technology described herein. The illustrative system 150 comprises a plurality of interrogator devices 102, which are part of an interrogator system 101. The interrogator devices 102 may be used to obtain estimates of a distance to one or more of the target devices 104. In turn, these distance estimates (e.g., together with the known positions of the interrogators relative to one another) may be used to estimate the position(s) of the target device(s) 104.

Each interrogator device 102 shown in FIG. 1C may be of any suitable type described herein. In some embodiments, the interrogator devices 102 may be of the same type of interrogator device. In other embodiments, at least two of these interrogator devices may be of different types. Some or all the interrogator devices 102 may be designed as described in connection with FIG. 1B, though in some embodiments, some of the components (e.g., waveform generator 110, control circuitry 118, external communications module 120 and/or transmit and receive circuitry 112) may be shared among multiple interrogator devices 102.

Although there are five interrogators shown as part of interrogator system 101, in other embodiments, any other suitable number of interrogators may be used (e.g., one, two, three, four, six, seven, eight, nine, ten, etc.), as aspects of the technology described herein are not limited in this respect. For example, in some embodiments, one interrogator device 102 may be configured to transmit RF signals to a target device 104 and receive RF signals from the same target device, whereas the other interrogator devices 102 may be receive-only interrogators configured to receive RF signals from the target device 104, but which are not capable of transmitting RF signals to target device 104 (e.g., because these interrogators may not include transmit circuitry for generating RF signals for transmission by a transmit antenna and/or the transmission antenna). It should also be appreciated that each of target devices 104 may be of any suitable type(s) described herein, as aspects of the technology described herein are not limited in this respect.

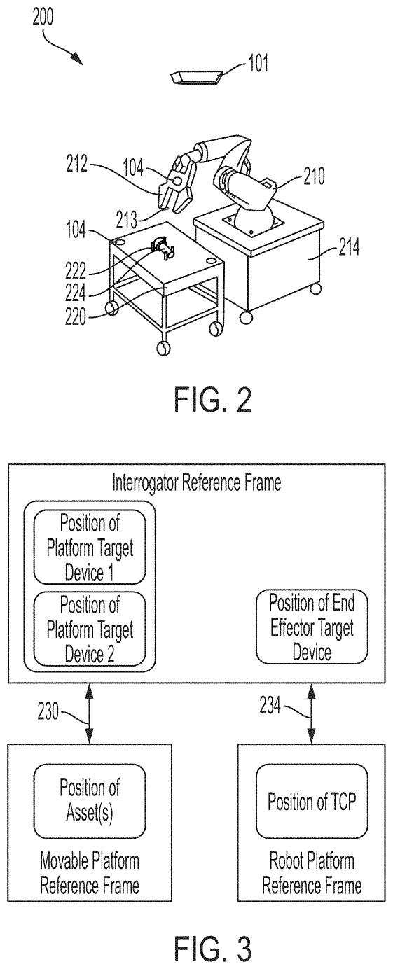

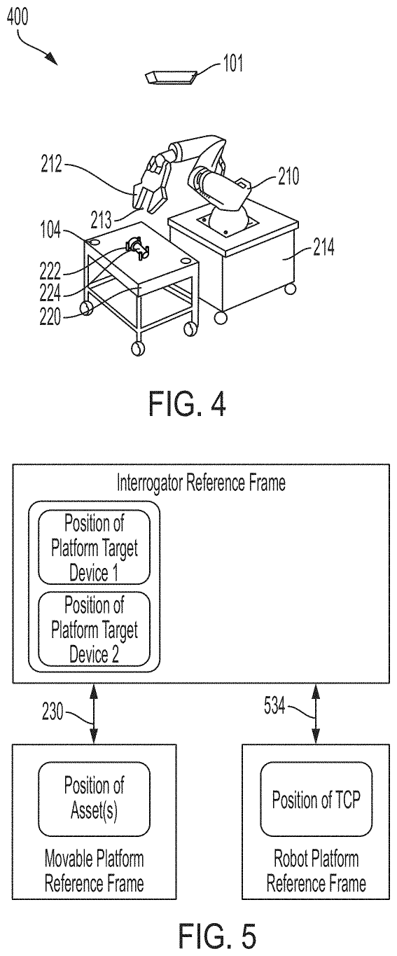

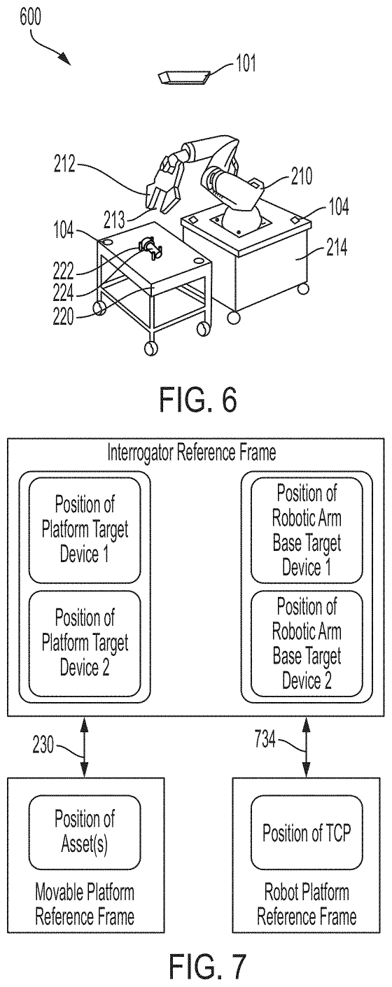

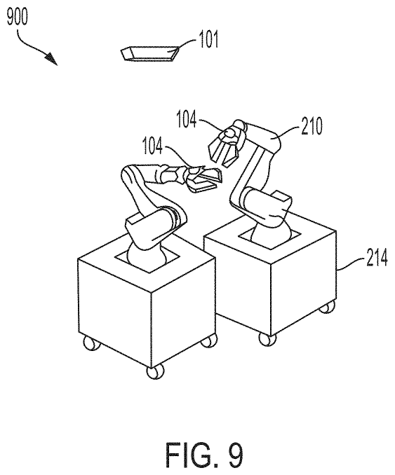

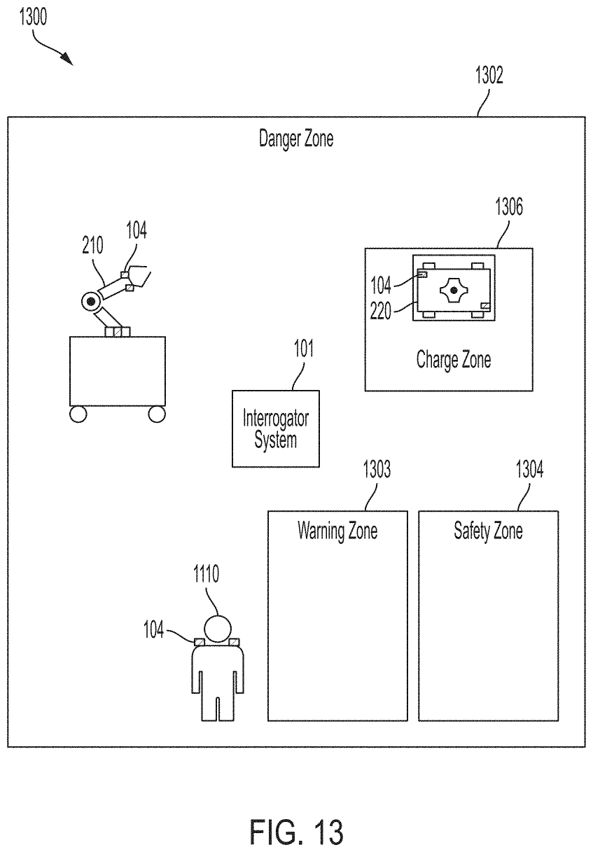

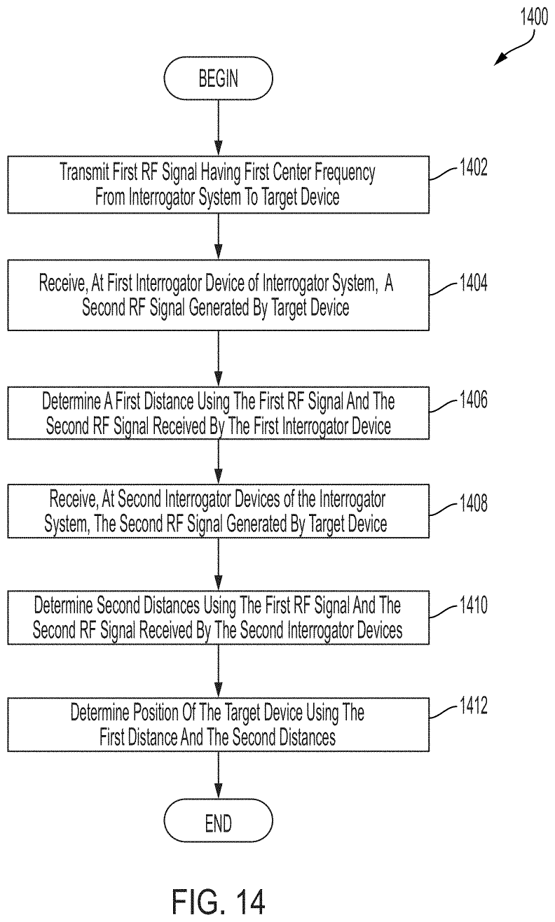

FIG. 14 is a flowchart of an illustrative process 1400 for determining the location of a target device using measurements made by an interrogator system including two receive antennas, in accordance with some embodiments of the technology described herein. Process 1400 may be executed by any suitable localization system described herein including, for example, system 100 described with reference to FIG. 1A, RF co-localization system 200 described with reference to FIG. 2, RF co-localization system 400 described with reference to FIG. 4, RF co-localization system 600 described with reference to FIG. 6, RF co-localization system 900 described with reference to FIG. 9, RF co-localization system 1100, and/or RF co-localization system 1300 described with reference to FIG. 13.

Process 1400 begins at act 1402, where the interrogator system transmits a first RF signal having a first center frequency to a target device. For example, the interrogator system 101 may send RF signal 103 to target device 104. The RF signal may be of any suitable type and, for example, may be a linear frequency modulated RF signal or any other suitable type of RF signal including any of the types of signals described herein. The first RF signal transmitted at act 1402 may have any suitable center frequency. For example, the center frequency may be any frequency in the range of 50-70 GHz (e.g., 60 GHz) or any frequency in the range of 4-6 GHz (e.g., 5 GHz). The first RF signal transmitted at act 1402 may be circularly polarized in the clockwise or counterclockwise direction.

At act 1404, the first interrogator system that, at act 1402, transmitted an RF signal to a target device, may receive a responsive second RF signal from the target device at a first interrogator device. For example, a first interrogator device 102 of the interrogator system 101 may receive second RF signal 105 from target device 104. The responsive second RF signal may be a transformed version of the transmitted first RF signal. The target device may generate the responsive RF signal by receiving and transforming the transmitted RF signal according to any of the techniques described herein.

In some embodiments, the frequency content of the responsive second RF signal received at act 1404 may be different from that of the transmitted RF signal transmitted at act 1402. For example, when the transmitted RF signal has a first center frequency, the responsive RF signal may have a second center frequency different from the first center frequency. For example, the second center frequency may be a harmonic of the first center frequency (e.g., the second center frequency may be an integer multiple of, such as twice as, the first center frequency). As one example, if the center frequency of the transmitted first RF signal were 60 GHz, then the center frequency of the responsive second RF signal may be 120 GHz, 180 GHz, or 240 GHz. In some embodiments, the polarization of the responsive second RF signal may be different from the polarization of the transmitted first RF signal. For example, when the transmitted first RF signal is circularly polarized in a clockwise direction, the received second RF signal may be circularly polarized in a counter-clockwise direction. Alternatively, when the transmitted first RF signal is circularly polarized in a counter-clockwise direction, the received second RF signal may be circularly polarized in a clockwise direction.

At act 1406, an estimate of the distance between the first interrogator device of the interrogator system and the target device may be determined by using the first RF signal transmitted at act 1402 and the second RF signal received at act 1404. This may be done in any suitable way. For example, in some embodiments, the first and second RF signals may be mixed (e.g., using a frequency mixer onboard the first interrogator device) to obtain a mixed RF signal. The mixed RF signal may be indicative of the time-of-flight and, consequently, the distance between the first receive antenna and the target device. The mixed RF signal may be sampled (e.g., using an ADC) and a Fourier transform (e.g., a discrete Fourier transform, a fast Fourier transform) may be applied to the samples to obtain a frequency-domain waveform. The frequency-domain waveform may be processed to identify the time-of-flight of an RF signal between the first receive antenna and the target device. In some embodiments, the frequency-domain waveform may be processed to identify the time-of-flight by identifying a first time when a responsive RF signal generated by the target device is detected by the first receive antenna of the interrogator device. This may be done in any suitable way. For example, the frequency-domain waveform may include multiple separated “peaks” (e.g., multiple Gaussian-like bumps each having a respective peak above the noise floor) and the location of the first such peak may indicate the first time when the responsive RF signal generated by the target is detected by the first receive antenna of the interrogator device. This first time represents an estimate of the time-of-flight between the first receive antenna and target device. In turn, the estimate of the time-of-flight between the first receive antenna and the target device may be converted to an estimate of the distance between the first receive antenna and the target device.

Accordingly, in some embodiments: (1) an interrogator system may transmit an RF signal to a target device and receive at a first interrogator device, from the target device, a responsive RF signal; (2) a version of the transmitted RF signal may be mixed with the received RF signal to obtain a mixed RF signal; (3) the mixed RF signal may be sampled using an ADC to obtain a sampled signal; (4) the sampled signal may be transformed by a discrete Fourier transform to obtain a frequency-domain waveform; (5) the frequency-domain waveform may be processed to identify the time-of-flight between the first interrogator device and the target device; and (6) the time-of-flight may be converted to an estimate of the distance between the first interrogator device and the target device.

It should be appreciated that while all of these acts 1-6 may be performed on a single device (e.g., the interrogator system), this is not a limitation of aspects of the technology described herein. For example, in some embodiments, an interrogator system may not include an ADC, and steps 3-6 may be performed by one or more devices external to an interrogator system. Even in embodiments where the interrogator system includes an ADC, the acts 4-6 may be performed by one or more device (e.g., a processor) external to the interrogator system.

At act 1408, the first interrogator system that, at act 1402, transmitted an RF signal to a target device, may receive the responsive second RF signal from the target device at second interrogator devices different than the first interrogator device.

At act 1410, an estimate of the distances between the second interrogator devices and the target device may be determined by using the received second RF signal received by the second interrogator devices at act 1408. This may be done in any suitable way including in any of the ways described above with reference to act 1406.

At act 1412, the position of the target device may be determined using the distance between the first interrogator device and the target device obtained at act 1406, the distances between the second interrogator devices and the target device obtained at act 1410, and known locations of the first and second interrogator devices. This determination may be made in any suitable way and, for example, may be made using any of numerous types of geometric methods, least-squares methods, trilateration methods, and/or in any of the ways described in U.S. Pat. No. 10,591,592 titled “High-Precision Time of Flight Measurement Systems,” filed on Jun. 14, 2016, U.S. Patent Publication No. 2016/0363648 titled “High Precision Motion Tracking with Time of Flight Measurement Systems,” filed on Jun. 14, 2016, U.S. Patent Publication No. 2016/0363664 titled “High Precision Subsurface Imaging and Location Mapping with Time of Flight Measurement Systems,” filed on Jun. 14, 2016, and U.S. Patent Publication No. 2016/0363663 titled “High-Precision Time of Flight Measurement System for Industrial Automation,” filed on Jun. 14, 2016, and in “Closed-form algorithms in mobile positioning: Myths and misconceptions,” N. Sirola, 2010 7th Workshop on Positioning, Navigation and Communication, 2010, pp. 38-44, each of which is herein incorporated by reference in its entirety.

It should be appreciated that process 1400 is illustrative and that there are variations. For example, in some embodiments, more than two receive antennas or more than two interrogator devices may be used to interrogate a single target device. In such embodiments, estimates of distances between the target device and each of the three or more receive antennas and/or interrogator devices may be used to obtain the two-dimensional position of the target devices (e.g. to specify a two-dimensional plane containing the three-dimensional target devices). When distances between at least three receive antennas and/or interrogator devices and a target device are available, then the three-dimensional position of the target device may be determined. Additional aspects of associated technology for performing RF localization are described in U.S. Pat. No. 10,094,909 titled “Radio-Frequency Localization Techniques and Associated Systems, Devices, and Methods,” filed on Jul. 28, 2017, which is herein incorporated by reference in its entirety.

FIG. 2 shows an example of an RF co-localization system200 configured to use RF localization techniques to cause a robotic arm 210 to interact with a movable platform 220, in accordance with some embodiments of the technology described herein. The RF co-localization system 200 includes an interrogator system 101 (e.g., interrogator system 101 as described in connection with FIGS. 1A, 1B, 1C, and 14) disposed above the environment in which the robotic arm 210 and movable platform 220 are interacting. For example, the interrogator system 101 may be coupled to the ceiling or other support structure above or adjacent the environment. The RF co-localization system 200 further includes target devices 104 (e.g., target devices 104 as described in connection with FIGS. 1A, 1B, 1C, and 14) coupled to the robotic arm 210 and the movable platform 220 to enable co-localization and coordinated interactions.

In some embodiments, the robotic arm 210 is supported by a robot platform 214. It should be appreciated that the robot platform 214 may be stationary (e.g., permanently or temporarily fixed in position) or movable (e.g., consisting of a movable platform such as, for example, an AGV or a manually-positionable platform). The end effector 212 may include a gripping device, as shown in the example of FIG. 2, or other tool (e.g., a drill, screwdriver, or other suitable tool) and/or a sensing device (e.g., an optical sensor, a thermal sensor, or other suitable sensing device). As shown in the example of FIG. 2, a target device 104 may be positioned on the end effector 212 of the robotic arm 210.

In some embodiments, the operational position of the end effector 212 may be defined by the tool center point (TCP) 213, which is the position at which the end effector 212 performs its task. As shown in the example of FIG. 2, the TCP 213 is positioned at the center position between the two gripping portions of the end effector 212, such that the TCP 213 is positioned where the gripping tool performs its gripping action. For other tools, the TCP 213 may be positioned, for example, at the operational end of the tool (e.g., at the free end of a drill, at the sensing end of a sensing device, etc.).

In some embodiments, and as shown in the example of FIG. 2, the position of the TCP 213 may be defined within the robot platform reference frame with respect to the position of the target device 104 positioned on the end effector 212. In some embodiments, the position of the TCP 213 may be defined based on information obtained from the robotic arm 210. For example, the obtained information may be information including the position of the robotic arm 210, its joints, and/or the end effector 212 within the robot platform reference frame. In some embodiments, the information may be obtained from, for example, an API of the robotic arm 210.

In some embodiments, the RF co-localization system 200 includes a movable platform 220. In some embodiments, and as shown in the example of FIG. 2, the movable platform 220 may be a manually-positionable platform (e.g., a cart or other movable platform). In some embodiments, the movable platform 220 may be an automated movable platform (e.g., an AGV, a platform associated with a production line, a conveyor belt, etc.).

In some embodiments, the movable platform 220 includes at least one target device 104 positioned at a known location on the surface of the movable platform 220. As shown in the example of FIG. 2, the movable platform 220 may include two target devices 104 such that the three-dimensional position of the movable platform 220 may be determined. It should be appreciated that in some embodiments, three or more target devices 104 may be coupled to the movable platform 220. In such embodiments, the position of the movable platform 220 may be determined with respect to its six degrees of freedom (6DOF).

In some embodiments, the movable platform 220 includes fixtures 222 configured to position an object 224 relative to the surface of the movable platform 220. The fixtures 222 may include any suitable component configured to position the object 224 in a known location and/or orientation. For example, the fixtures 222 may include pegs, prongs, clamps, cords, walls, ledges, or other supports configured to hold the object 224 in a fixed position. Alternatively or additionally, the fixtures 222 may include holes or slots configured to accept mating portions of the object 224. In some embodiments, the fixtures 222 are positioned on the surface of the movable platform 220 at known positions relative to the target devices 104. Accordingly, the position of the object 224 in a common reference frame associated with the interrogator system may then be determined based on the positions of the target devices 104.

In some embodiments, the RF co-localization system 200 may be configured such that the robotic arm 210 performs a task with respect to the object 224 supported by the movable platform 220. For example, and as shown in the example of FIG. 2, the robotic arm 210 may be configured to pick up an object 224 from the movable platform 220 in order to move the object 224 to another workstation and/or to perform a secondary process on the object 224. As an example, the object 224 may be a car door handle that has been initially cast in iron. The robotic arm 210 may be configured to pick up the door handle and move it to a CNC machine for a finishing process (e.g., polishing or milling). Alternatively or additionally, in some embodiments the robotic arm 210 may be configured to place an object 224 on the movable platform 220. For example, the robotic arm 210 may be configured to return the finished door handle to the movable platform 220 after it is finished being processed by the CNC machine.

In some embodiments, the end effector 212 may be a tool rather than a gripping device as shown in the example of FIG. 2. In such embodiments, the robotic arm 210 may be configured to perform the task by altering a characteristic of the object 224. For example, in some embodiments, the end effector 212 may be a drilling tool configured to drill holes into the object 224. Alternatively, as another example, in some embodiments the end effector 212 may be a fastening tool (e.g., a screwdriver, a torque wrench, etc.) configured to affix something to the object 224 and/or affix the object 224 to another object.

In some embodiments, the end effector 212 may be a sensing device rather than a gripping device as shown in the example of FIG. 2. In such embodiments, the robotic arm 210 may be configured to perform the task by using the sensing device to determine information about the object. For example, in some embodiments the end effector 212 may be an optical sensor configured to determine information about the object using optical measurements. As an example, the optical sensor may be a spectrometer configured to determine a concentration of certain compounds in the object 224. Alternatively or additionally, in some embodiments the end effector 212 may be a thermal sensor configured to determine information about the object using thermal measurements. As an example, the thermal sensor may be configured to measure a temperature of the object 224 during a manufacturing process to determine whether the object 224 has not experienced undue thermal stress during manufacturing.

In some embodiments, the robotic arm 210 may be configured to interact with the movable platform 220 when the movable platform 220 has come to a stopped position adjacent the robotic arm 210. In some embodiments, the robotic arm 210 may be configured to interact with the movable platform 220 when the movable platform 220 is in continuous motion (e.g., moving past the robotic arm 210).

The operation of the RF co-localization system 200 will be described herein with reference to FIG. 3, which shows a schematic diagram illustrating an example of the device positions and reference frames of RF co-localization system 200, in accordance with some embodiments of the technology described herein. In some embodiments, the RF co-localization system 200 is calibrated prior to usage. In some embodiments, the position of the object 224 may be determined relative to the target devices 104 coupled to the movable platform 220. In some embodiments, the positions of multiple objects 224 may be determined relative to the target devices 104 coupled to the movable platform 220.

In some embodiments, a transformation 230 is determined between a common reference frame (e.g., a coordinate system associated with the interrogator system 101) and a reference frame associated with the movable platform 220. The transformation 230 may be determined, for example, by determining a transformation matrix (e.g., a homogeneous transformation matrix) between the two reference frames using any suitable algorithm. For example, in some embodiments the transformation 230 may be determined using the Kabsch algorithm. Additional aspects of the Kabsch algorithm are described in “A solution for the best rotation to relate two sets of vectors,” Kabsch, W., Acta Cryst A 1976;32:9223 and “A discussion of the solution for the best rotation to relate two sets of vectors,” Kabsch, W., Acta Cryst A 1978;34:8278, both of which are incorporated herein by reference in their entirety.

In some embodiments, the transformation 230 may be used to determine the position of the object 224 within the common reference frame. For example, the transformation 230 may be used to transform the position of the object 224 within the reference frame associated with the movable platform 220 to the common reference frame by applying the transformation 230 to the position of the object 224 within the reference frame associated with the movable platform 220.

In some embodiments, a transformation 234 between the common reference frame and a reference frame associated with the robot platform 214 may also be determined. The transformation 234 can be determined by positioning a target device 104 at a known location on the robotic arm 210. For example, the target device 104 may be positioned on the end effector 212 or at the TCP 213, in some embodiments. Then, the end effector 212 may be moved to at least three non-collinear positions in three-dimensional space. At each position of the at least three positions, a position of the target device 104 is determined, from information obtained from the robotic arm 210, within the reference frame associated with the robot platform. Additionally, at each position of the at least three positions, a position of the target device 104 within the common reference frame is determined using the interrogator device 101.

In some embodiments, the transformation 234 is then determined using the obtained at least three positions of the target device 104 within the two reference frames. The transformation 234 may be determined, for example, by determining a transformation matrix (e.g., a homogeneous transformation matrix) between the two reference frames using any suitable algorithm. For example, in some embodiments the transformation 234 may be determined using the Kabsch algorithm. During usage, the transformation 234 may be used to determine the position of the TCP 213 within the common reference frame by transforming the position of the TCP 213 within the reference frame associated with the robot platform 214 to the common reference frame.

In some embodiments, operation of the RF co-localization system 200 may begin when the movable platform 220 approaches and/or stops adjacent to the robotic arm 210. The interrogator system 101 may be controlled to transmit first RF signals (e.g., RF signals 103) to the target devices 104 coupled to the robotic arm 210 and the movable platform 220. Responsive to the first RF signals, the target devices 104 may transmit second RF signals (e.g., RF signals 105) that are received by the interrogator system 101.

In some embodiments, a controller (not shown) communicatively coupled to the interrogator system 101 is configured to determine the current position of the end effector 212 and the position of the movable platform 220 in the common reference frame. The current position of the end effector 212 and the position of the movable platform may be determined using the second RF signals received from the target devices 104. For example, the controller may be configured to determine distances between interrogator devices 102, as described in connection with FIGS. 1A, 1B, and 1C, of the interrogator system 101 and the target devices 104 using the second RF signals received from the target devices 104. Using the distances between the receive antennas of the interrogator device 101 and each of the target devices 104, the controller may be configured to determine a position of each of the target devices 104 within the common reference frame (e.g., using process 1400 as described herein).

In some embodiments, the controller is also configured to determine a position of the movable platform 220 within the common reference frame. The controller may be configured to determine the position of the movable platform 220 using the determined positions of the target devices 104 coupled to the movable platform 220. For example, the controller may be configured to determine the position of an origin point of the movable platform 220 (e.g., a center of the surface of the movable platform 220, a corner of the movable platform 220, a center of mass of the movable platform 220) within the common reference frame using the determined positions of each of the target devices 104 within the common reference frame.

In some embodiments, the controller is also configured to determine the position of the object 224 within the common reference frame. For example, the controller may be configured to determine the position of the object 224 within the common reference frame using transformation 230 and the position of the movable platform 220. In some embodiments, the controller may be configured to determine the position of the object 224 using the known position of the object 224 relative to the target devices 104 (e.g., as obtained during calibration) within the reference frame associated with the movable platform 220.

In some embodiments, the controller is also configured to determine a target position to which to move the end effector 212 of the robotic arm 210 in order to perform the task with respect to the object 224. For example, the target position may be a position at which the TCP 213 may be moved to in order to perform the task at the target position. In some embodiments, the target position may be determined relative to the position of the movable platform 220 in the common reference frame and/or relative to the position of the object 224 in the common reference frame. For example, as in the example of FIG. 2, the target position may be determined to be a center of mass of the object 224 such that, when the target position is used to generate a command to cause the robotic arm 210 to move to the target position, the TCP 213 will be moved to the center of mass of the object 224, enabling the end effector 212 to pick up the object 224.

In some embodiments, the controller is also configured to determine a travel vector of the end effector 212 within the reference frame associated with the robot platform 214. The travel vector may be a vector between a current position of the end effector within the robot platform reference frame and a target position of the end effector within the robot platform reference frame. The controller may be configured to determine the travel vector using a current position of the end effector 212 within the common reference frame, the target position within the common reference frame, and the transformation 234. For example, the controller may be configured to find a difference between the current position of the end effector 212 and the target position within the common reference frame and thereafter apply the transformation 234 to determine the travel vector within the reference frame associated with the robot platform 214. Alternatively, in some embodiments the controller may be configured to use the transformation 234 to determine the current and target positions within the reference frame associated with the robot platform 214, and thereafter to determine the travel vector within the reference frame associated with the robot platform 214 using the current and target positions with the reference frame associated with the robot platform 214.

In some embodiments, the controller is also configured to generate a command to cause the end effector 212 to travel to the target position. For example, the controller may be configured to add the travel vector to the current TCP position of the robotic arm 210 (e.g., as stored by the robotic arm 210) to cause the end effector 212 to travel to the target position. In some embodiments, the above-described process may be repeated iteratively until the TCP 213 of the robotic arm 210 reaches the desired position.

FIG. 4 shows an example of an RF co-localization system 400 configured to use RF localization techniques to cause a robotic arm to interact with a movable platform, in accordance with some embodiments of the technology described herein. The RF co-localization system 400 is similar in configuration to the RF co-localization system 200 described in connection with the example of FIG. 2, but the RF co-localization system 400 may not include target devices 104 coupled to the robotic arm 210 or the robot platform 214.

Operation of the RF co-localization system 400 will be described herein with reference to FIG. 5, which shows a schematic diagram illustrating an example of the device positions and reference frames of RF co-localization system 400, in accordance with some embodiments of the technology described herein. In some embodiments, the RF co-localization system 400 is calibrated prior to usage. During a calibration stage prior to the usage of the RF co-localization system 400, the position of the object 224 may be determined and/or set relative to the target devices 104 coupled to the movable platform 220. In some embodiments, the positions of multiple objects 224 may be determined relative to the target devices 104 coupled to the movable platform 220.

In some embodiments, the transformation 230 may be determined for RF co-localization system 400 as it was described in connection with RF co-localization system 200. The transformation 230 is determined between the common reference frame and a reference frame associated with the movable platform 220. The transformation 230 may be used to determine the position of the object 224 within the common reference frame by transforming the position of the object 224 within the reference frame associated with the movable platform 220 to the common reference frame.

In some embodiments, a transformation 534 may be determined between the common reference frame and a reference frame associated with the robot platform 214. To determine transformation 534, target devices may be placed at known locations on the robot platform 214, the known locations being within the reference frame associated with the robot platform 214. The positions of the placed target devices may then be determined within the common reference frame using the interrogator system 101 (e.g., as described in connection with FIG. 14). The transformation 534 may then be determined using the determined positions of the calibration target devices within the common reference frame. In some embodiments, the transformation 534 may be determined, for example, by determining a transformation matrix (e.g., a homogeneous transformation matrix) between the two reference frames using any suitable algorithm. For example, in some embodiments the transformation 534 may be determined using the Kabsch algorithm. The transformation 534 may be used to determine the position of the TCP 213 within the common reference frame by transforming the position of the TCP 213, as obtained from the robotic arm 210, within the reference frame associated with the robot platform 214 to the common reference frame. In some embodiments, after determining transformation 534, the target devices may be removed from the robot platform 214.

In some embodiments, operation of the RF co-localization system 400 may begin when the movable platform 220 approaches and/or stops adjacent to the robotic arm 210. The interrogator system 101 may be controlled to transmit first RF signals (e.g., RF signals 103) to the target devices 104 coupled to the movable platform 220. Responsive to the first RF signals, the target devices 104 may transmit second RF signals (e.g., RF signals 105) that are received by the interrogator system 101.

In some embodiments, a controller (not shown) communicatively coupled to the interrogator system 101 may be configured to determine the position of the movable platform 220 and the object 224 within the common reference frame associated with the interrogator system 101 using the second RF signals received from the target devices 104 and transformation 230. The controller may be configured to determine the position of the movable platform 220 and the object 224 within the common reference frame as described in connection with the example of RF co-localization system 200.

In some embodiments, the controller is also configured to determine a target position to which to move the end effector 212 of the robotic arm 210 in order to perform the task with respect to the object 224. The controller may be configured to determine the target position within the same manner as described in connection with RF co-localization system 200.

In some embodiments, the controller is also configured to determine a current position of the end effector 212 within the reference frame associated with the robot platform 214. For example, the controller may be configured to access information indicative of the current position of the end effector 212. In some embodiments, the controller may be configured to access the information indicative of the current position of the end effector 212 from the robotic arm 210. For example, the controller may be configured to access the information using an API of the robotic arm 210.

In some embodiments, the controller is also configured to determine a travel vector of the end effector 212 within the reference frame associated with the robot platform 214. The controller may be configured to determine the travel vector using a current position of the end effector 212 within the reference frame associated with the robot platform 214 and the target position within the common reference frame. In some embodiments, to determine the travel vector, the controller may be configured to apply transformation 534 to the target position within the common reference frame to determine the target position within the reference frame associated with the robot platform 214. The controller may be configured to determine the travel vector within the reference frame associated with the robot platform 214 by determining a difference between the target position and the current position within the reference frame associated with the robot platform 214. It should be appreciated that in some embodiments, and alternatively, the transformation 534 may be applied to the obtained current position of the end effector 212 to determine the travel vector within the common reference frame and thereafter the transformation 534 can be applied to the travel vector within the common reference frame to determine the travel vector within the reference frame associated with the robot platform 214.

In some embodiments, the controller is configured to generate a command to cause the end effector 212 to travel to the target position within the reference frame associated with the robot platform 214. For example, the controller may be configured to add the travel vector to the current TCP position of the robotic arm 210 (e.g., as stored by the robotic arm 210) to cause the end effector 212 to travel to the target position. In some embodiments, the above-described process may be repeated until the TCP 213 of the robotic arm 210 reaches the desired position.

FIG. 6 shows an example of an RF-localization system 600 configured to use RF localization techniques to cause a robotic arm to interact with a movable platform, in accordance with some embodiments of the technology described herein.

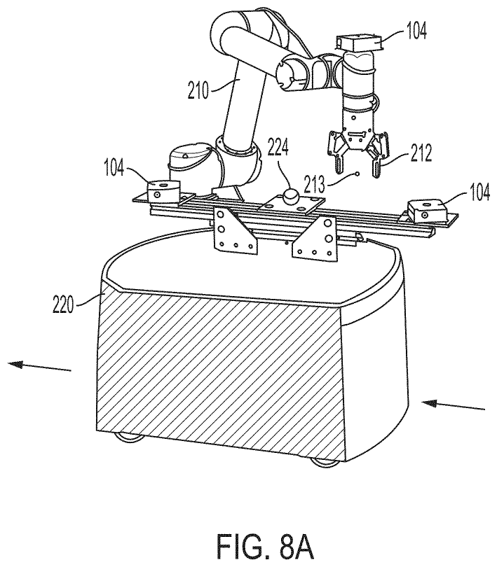

FIG. 7 shows a schematic diagram illustrating an example of how to determine positions of items within system 600, in accordance with some embodiments of the technology described herein.

FIG. 6 shows an example of an RF co-localization system 600 configured to use RF localization techniques to cause a robotic arm to interact with a movable platform, in accordance with some embodiments of the technology described herein. The RF co-localization system 600 is similar in configuration to the RF co-localization system 200 described in connection with the example of FIG. 2, but the RF co-localization system 600 may include one or more target devices 104 coupled to the robot platform 214. In the example of FIG. 6, two target devices 104 are shown coupled to the robot platform 214.

Operation of the RF co-localization system 600 will be described herein with reference to FIG. 7, which shows a schematic diagram illustrating an example of the device positions and reference frames of RF co-localization system 600, in accordance with some embodiments of the technology described herein. In some embodiments, the RF co-localization system 600 is calibrated prior to usage. During calibration, the position of the object 224 may be determined relative to the target devices 104 coupled to the movable platform 220. In some embodiments, the positions of multiple objects 224 may be determined relative to the target devices 104 coupled to the movable platform 220.

In some embodiments, the transformation 230 may be determined for RF co-localization system 600 as it was described in connection with RF co-localization system 200. The transformation 230 is determined between the common reference frame and a reference frame associated with the movable platform 220. The transformation 230 may be used to determine the position of the object 224 within the common reference frame by transforming the position of the object 224 within the reference frame associated with the movable platform 220 to the common reference frame.

In some embodiments, a transformation 734 may be determined between the common reference frame and a reference frame associated with the robot platform 214. To determine transformation 734, the target devices 104 may be placed at known locations on the robot platform 214, the known locations being within the reference frame associated with the robot platform 214. The positions of the placed target devices may then be determined within the common reference frame using the interrogator system 101 (e.g., as described in connection with FIG. 14). The transformation 734 may then be determined using the determined positions of the target devices 104 within the common reference frame. In some embodiments, the transformation 734 may be determined, for example, by determining a transformation matrix (e.g., a homogeneous transformation matrix) between the two reference frames using any suitable algorithm. For example, in some embodiments the transformation 734 may be determined using the Kabsch algorithm. The transformation 734 may be used to determine the position of the TCP 213 within the common reference frame by transforming the position of the TCP 213, as obtained from the robotic arm 210, within the reference frame associated with the robot platform 214 to the common reference frame.

In some embodiments, operation of the RF co-localization system 600 may begin when the movable platform 220 approaches and/or stops adjacent to the robotic arm 210. The interrogator system 101 may be controlled to transmit first RF signals (e.g., RF signals 103) to the target devices 104 coupled to the movable platform 220. Responsive to the first RF signals, the target devices 104 may transmit second RF signals (e.g., RF signals 105) that are received by the interrogator system 101.

In some embodiments, a controller (not shown) communicatively coupled to the interrogator system 101 may be configured to determine the position of the movable platform 220 and the object 224 within the common reference frame associated with the interrogator system 101 using the second RF signals received from the target devices 104 and transformation 230. The controller may be configured to determine the position of the movable platform 220 and the object 224 within the common reference frame as described in connection with the example of RF co-localization system 200.

In some embodiments, the controller is also configured to determine a target position to which to move the end effector 212 of the robotic arm 210 in order to perform the task with respect to the object 224. The controller may be configured to determine the target position within the same manner as described in connection with RF co-localization system 200.

In some embodiments, the controller is also configured to determine a current position of the end effector 212 within the reference frame associated with the robot platform 214. For example, the controller may be configured to access information indicative of the current position of the end effector 212. In some embodiments, the controller may be configured to access the information indicative of the current position of the end effector 212 from the robotic arm 210. For example, the controller may be configured to access the information using an API of the robotic arm 210.

In some embodiments, the controller is also configured to determine a travel vector of the end effector 212 within the reference frame associated with the robot platform 214. The controller may be configured to determine the travel vector using a current position of the end effector 212 within the reference frame associated with the robot platform 214 and the target position within the common reference frame. In some embodiments, to determine the travel vector, the controller may be configured to apply transformation 734 to the target position within the common reference frame to determine the target position within the reference frame associated with the robot platform 214. The controller may be configured to determine the travel vector within the reference frame associated with the robot platform 214 by determining a difference between the target position and the current position within the reference frame associated with the robot platform 214. It should be appreciated that in some embodiments, and alternatively, the transformation 734 may be applied to the obtained current position of the end effector 212 to determine the travel vector within the common reference frame and thereafter the transformation 734 can be applied to the travel vector within the common reference frame to determine the travel vector within the reference frame associated with the robot platform 214.

In some embodiments, the controller is configured to generate a command to cause the end effector 212 to travel to the target position within the reference frame associated with the robot platform 214. For example, the controller may be configured to add the travel vector to the current TCP position of the robotic arm 210 (e.g., as stored by the robotic arm 210) to cause the end effector 212 to travel to the target position. In some embodiments, the above-described process may be repeated until the TCP 213 of the robotic arm 210 reaches the desired position.

In some embodiments, the RF co-localization system 600 may be configured such that robotic arm 210 interacts with the movable platform 220 when the movable platform 220 is in motion. For example, the robotic arm 210 may be configured to interact with the object 224 and/or to perform a task with respect to the object 224 as the movable platform 220 moves past the robotic arm 210.

In some embodiments, the controller may be configured to cause the robotic arm 210 to interact with the movable platform 220 when the movable platform 220 is in motion by performing a series of steps iteratively. The controller may be configured to iteratively determine a target position and/or travel vector of the end effector 212 as the movable platform 220 moves with respect to the robotic arm 210. The iterative determination may include first determining the position of the movable platform and the current position of the end effector within the common reference frame using the interrogator system 101. Thereafter, the controller may determine, using transformation 230 and the position of the movable platform in the common reference frame, the position of the object 224 within the common reference frame. The controller may next be configured to determine the target position of the end effector within the common reference frame using the position of the object in the common reference frame.

In some embodiments, the controller may next be configured to determine a travel vector for the end effector 212. The controller may be configured to determine the travel vector using the current position of the end effector within the common reference frame (e.g., as obtained from the robotic arm 210), the target position of the end effector within the common reference frame, and transformation 734. The controller may next generate a command to cause the robotic arm to move to the target position using the travel vector. The controller may be configured to iteratively perform these actions to cause the robotic arm 210 to track the object 224 as the movable platform 220 moves in the environment.

In some embodiments, the controller may be configured to determine whether the end effector 212 is tracking the object 224 closely enough to perform a desired task. The controller may be configured to, for example, use a Kalman filter to predict a motion model of the movable platform. While iterating the movement of the end effector 212, the controller may be configured to determine an error estimate of the Kalman filter to determine whether the end effector 212 is closely tracking the object 224. The controller may be configured to determine whether the error estimate is below a threshold value (e.g., such that the end effector 212 is closely tracking the object 224) prior to generating a command to cause the robotic arm 210 to perform the desired task with respect to the object 224. In some embodiments, the controller may be configured to use PID algorithms to determine whether the end effector 212 is tracking the object 224 closely enough to perform the desired task.

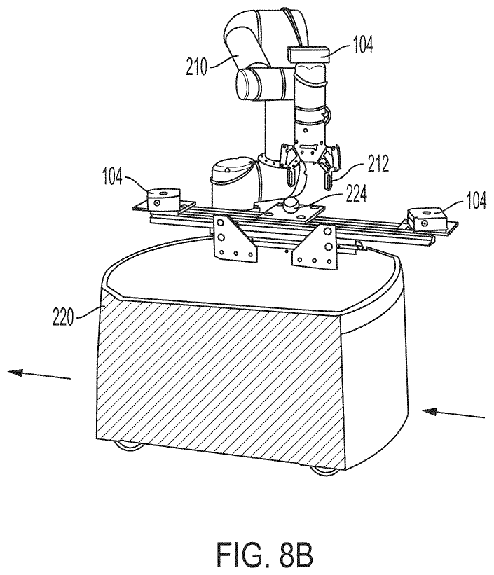

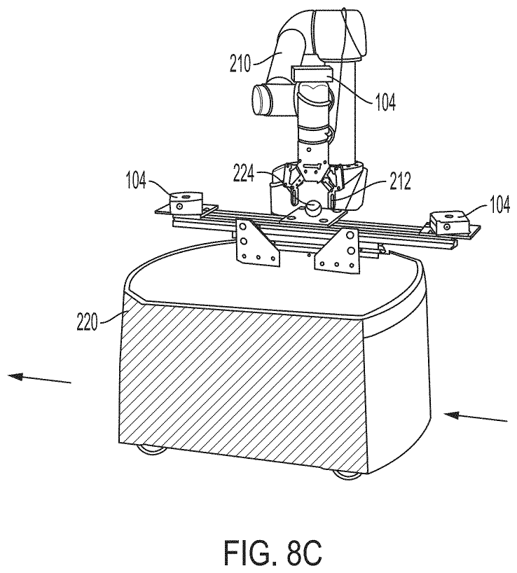

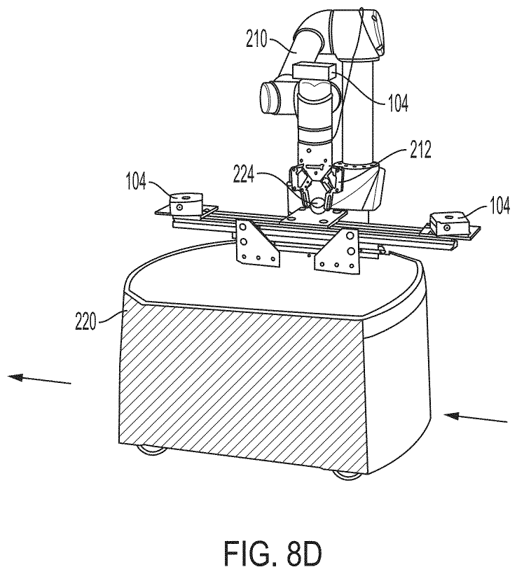

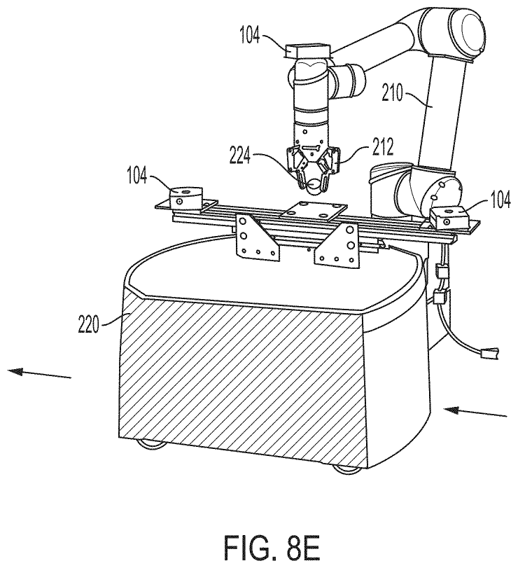

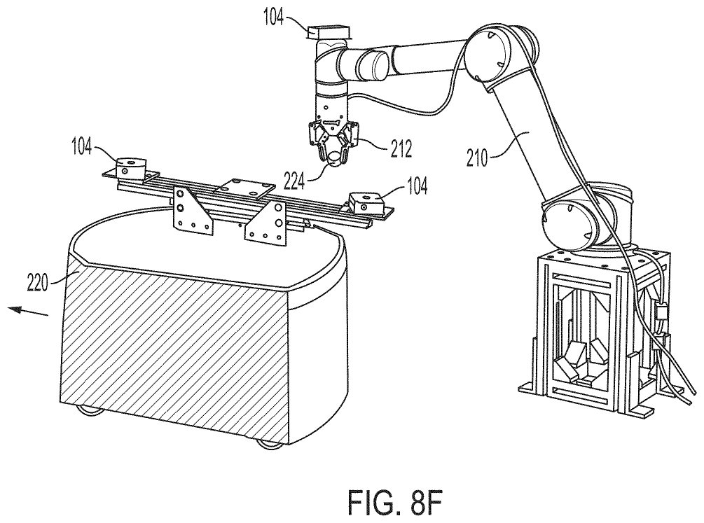

FIGS. 8A-8F provide an example of an RF co-localization system including a robotic arm 210 configured to track the motion of a movable platform 220 while the movable platform 220 is in motion, in accordance with some embodiments of the technology described herein. The system of FIGS. 8A-8F includes an interrogator system 101 (not shown) mounted above the robotic arm 210 and the movable platform 220. Target devices 104 are coupled to the end effector 212 of the robotic arm 210 and to the movable platform 220. An object 224 is supported by the movable platform 220 as the movable platform 220 moves through the environment.

In the example of FIG. 8A, the movable platform 220 approaches the robotic arm 210 from the right edge of the page. The robotic arm 210 is in a neutral position, with the end effector 212 positioned out of the path of travel of the movable platform 220. At this point, the interrogator system can determine the relative positions of the movable platform 220 and the robotic arm 210 by transmitting first RF signals to the target devices 104 and receiving second RF signals transmitted by the target devices 104 in response to the first RF signals. The interrogator system can determine the positions of the movable platform 220, the robotic arm 210, the object 224, and a first target position of the end effector 212 as described in connection with RF co-localization system 200.

In the example of FIG. 8B, a command has been generated to cause the robotic arm 210 to start moving the end effector 212 to the first target position. The interrogator system may iteratively perform the acts of determining the relative positions of the robotic arm 210 and the movable platform and determining a new target position as the movable platform 220 moves from right to left past the end effector 212. In some embodiments, the interrogator system may be configured to repeat these determinations at a rate that is faster than the rate of change of position of the movable platform 220 so that the robotic arm 210 may smoothly track the movable platform 220. For example, the interrogator system may be configured to iteratively perform these acts every millisecond or every few milliseconds.

In the example of FIG. 8C, a command has been generated to cause the robotic arm to move the end effector 212 to a subsequently-determined target position adjacent the object 224. The robotic arm 210 has been precisely and accurately positioned such that the TCP 213 of the robotic arm 210 is positioned at a same position as the object 224. While the TCP 213 of the robotic arm 210 is positioned in an overlapping fashion with the position of the object 224, the robotic arm 210 can be said to be “tracking” the object 224 as the movable platform 220 is in motion.

In the examples of FIGS. 8D, 8E, and 8F the robotic arm performs a task with respect to the object 224 while the movable platform 220 remains in motion. In the examples of FIGS. 8D and 8E, the robotic arm is configured to grasp the object 224 using the end effector 212, pick up the object 224 from the movable platform 220, and move the object 224 to another position away from the path of travel of the movable platform 220. It should be appreciated that in other embodiments, the robotic arm 210 may be configured to perform a different task with respect to the object 224. For example, the robotic arm 210 may be configured to use a tool to alter an aspect of the object 224 while the movable platform 220 moves. Alternatively, in some embodiments, the robotic arm 210 may be configured to use a sensing device to determine information about the object 224 while the movable platform 220 moves.

In some embodiments, multiple robotic arms may be interacting within an environment. FIG. 9 shows an example of an RF co-localization system 900 configured to use RF localization techniques to facilitate interactions among robotic arms, in accordance with some embodiments of the technology described herein. RF co-localization system 900 includes two robotic arms 210, each supported by robot platforms 214. One or more of the robot platforms 214 may be movable in the environment. For example, in some embodiments one of the robot platforms 214 may be stationary while the other robot platform 214 may be manually or autonomously movable such that the two robotic arms 210 interact when the movable robot platform 214 is positioned adjacent the stationary robot platform 214. As another example, in some embodiments, both robot platforms may be manually or autonomously movable in the environment such that the two robotic arms 210 interact when the robot platforms 214 are moved adjacent one another. As another example, in some embodiments, both robot platforms may be stationary and placed adjacent one another during operation such that the two robotic arms 210 interact during operation.

In some embodiments, the RF co-localization system 900 includes an interrogator system 101 (e.g., as described in connection with FIGS. 1A, 1B, 1C, and 14) and target devices 104 (e.g., as described in connection with FIGS. 1A, 1B, 1C, and 14). The target devices 104 may be coupled to the robotic arms 210 and/or the robot platforms 214. As shown in the example of FIG. 9, the target devices 104 may be coupled to the end effectors 212 of the robotic arms 210. In some embodiments, one or more target devices 104 may be coupled to the robot platforms 214 (e.g., as described in connection with FIGS. 6 and 7 herein).

In some embodiments, a controller associated with the interrogator system 101 may be configured to iteratively determine travel vectors for one or more of the robotic arms 210 such that the robotic arms 210 do not interfere and/or collide with one another. The controller may be configured to iteratively determine the positions of one or more of the end effectors 212 of the robotic arms 210 using the target devices 104 (e.g., as described in connection with the examples of FIGS. 2 and 3 herein). The controller may further be configured to determine travel vectors for the one or more end effectors 212 to target positions (e.g., as described in connection with the examples of FIGS. 2 and 3 herein). In some embodiments, the controller may be configured to determine travel vectors for the one or more end effectors 212 based on position(s) of objects with which the robotic arms 210 are configured to perform a task. In some embodiments, the controller may be configured to determine travel vectors for the one or more end effectors 212 based on a combined interaction of the robotic arms 210 (e.g., to cause a first robotic arm to pass an object to the second robotic arm).

In some embodiments, the controller may be configured to generate commands to cause the robotic arms 210 to move based on the determined travel vectors. In some embodiments, the generated commands may include commands to move joint(s) of the robotic arms in pre-determined or pre-set ways to cause smooth motion of the robotic arms 210 and/or to prevent collision of the robotic arms 210. For example, in some embodiments the controller may be configured to determine the inverse kinematics for the robotic arms 210 based on the determined target position. In some embodiments, the controller may be configured to determine the inverse kinematics for the robotic arms 210 using pre-determined or pre-set joint angles of the robotic arms 210. Based on these desired joint angles, the controller may then be configured to compare the desired joint angles with the actual joint angles of the robotic arms 210 and, by using a control algorithm (e.g., a proportional-integral-derivative (PID) algorithm, a model predictive control (MPC) algorithm, or any other suitable control algorithm for controlling a robotic arm, as aspects of the technology described herein are not limited in this respect), determine joint speeds to cause the robotic arms 210 to move to the determined target positions smoothly and safely. The controller may be configured to continuously update the joint speeds until the robotic arms 210 arrive at the determined target positions.

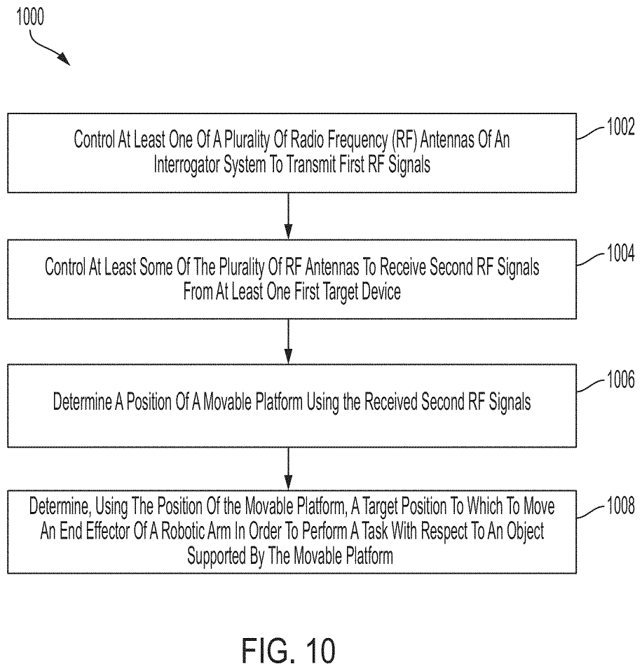

FIG. 10 is a flowchart of an illustrative process 1000 for determining the target location of an end effector of a robotic arm, in accordance with some embodiments of the technology described herein. Process 1000 may be executed by any suitable localization system described herein including, for example, system 100 described with reference to FIG. 1A, RF co-localization system 200 described with reference to FIG. 2, RF co-localization system 400 described with reference to FIG. 4, RF co-localization system 600 described with reference to FIG. 6, RF co-localization system 900 described with reference to FIG. 9, and/or RF co-localization system 1300 described with reference to FIG. 13.

Process 1000 begins at act 1002, where a controller communicatively coupled to an interrogator system (e.g., interrogator system 101 as described in connection with FIG. 1A, 1B, 1C, and 14) controls at least one of a plurality of RF antennas of the interrogator system to transmit first RF signals. For example, the interrogator system may transmit the first RF signals to at least a first target device (e.g., target device 104 as described in connection with FIGS. 1A, 1B, 1C, and 14) coupled to a movable platform positioned within the environment of the interrogator system. In some embodiments, the first RF signal may be of any suitable type and, for example, may be a linear frequency modulated RF signal or any other suitable type of RF signal including any of the types of signals described herein. The first RF signal transmitted at act 1002 may have any suitable center frequency. For example, the center frequency may be any frequency in the range of 50-70 GHz (e.g., 60 GHz) or any frequency in the range of 4-6 GHz (e.g., 5 GHz). The first RF signal transmitted at act 1002 may be circularly polarized in the clockwise or counterclockwise direction.

After act 1002, the process 1000 may proceed to act 1004, where the controller may control at least some of the plurality of RF antennas to receive second RF signals from at least the first target device. The second RF signals may be generated by target devices within the environment of the interrogator system in response to receiving the first RF signal transmitted by the interrogator system. The responsive second RF signal may be a transformed version of the transmitted first RF signal. The target device may generate the responsive RF signal by receiving and transforming the transmitted RF signal according to any of the techniques described herein.

After act 1004, the process may proceed to act 1006, where the controller may determine a position of the movable platform using the received second RF signals. In some embodiments, the controller may determine the position of the movable platform in a common reference frame associated with the interrogator system. In some embodiments, the controller may determine the position of the movable platform by first determining an estimate of the distances between at least some of the plurality of RF antennas and at least the first target device coupled to the movable platform. The controller may determine the estimate of the distances between at least some of the plurality of RF antennas and at least the first target device coupled to the movable platform in any suitable way. For example, the controller may use the process 1400 as described in connection with FIG. 14 herein to determine the estimate of the distances and the position of the movable platform within the common reference frame.

After act 1006, the process may proceed to act 1008, where the controller may determine a target position to which to move an end effector of a robotic arm in order to perform a task with respect to an object supported by the movable platform. The controller may determine the target position using the position of the movable platform determined in act 1006. In some embodiments, the controller may determine the target position using a transformation (e.g., transformation 230 as described in connection with FIGS. 2 and 3) to determine a position of an object supported by the movable platform in the common reference frame. The controller may determine the target position using the position of the object in the common reference frame. In some embodiments, the controller may determine the target position in a reference frame associated with the robot platform using another transformation (e.g., transformation 234 as described in connection with FIGS. 2 and 3) to transform the target position in the common reference frame to a position in the reference frame associated with the robot platform. In some embodiments, the controller may determine the target position in the reference frame associated with the robot platform as a position of the TCP of the robotic arm. In some embodiments, the controller may determine the target position in the reference frame associated with the robot platform based on a given offset determined, for example, by the type of tool attached to the end effector of the robotic arm.

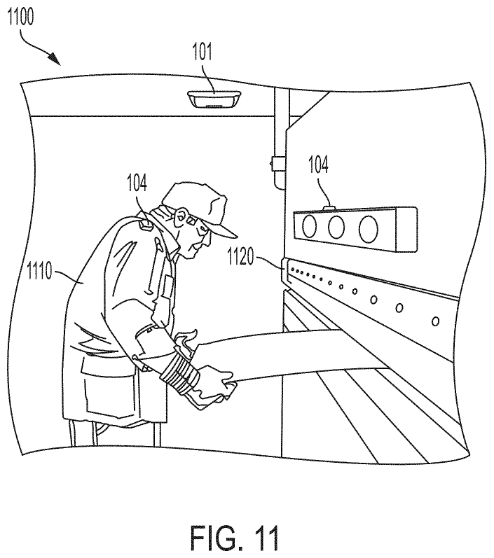

FIG. 11 shows an example of an RF co-localization system 1100 configured to use RF localization techniques to determine whether a person has entered an operating volume associated with machinery, in accordance with some embodiments of the technology described herein. The RF co-localization system 1100 includes an interrogator system 101 (e.g., interrogator system 101 as described in connection with FIGS. 1A, 1B, 1C, and 14) positioned on a ceiling above the environment and a controller (not shown) communicatively coupled to the interrogator system 101.

In some embodiments, the RF co-localization system 1100 also includes target devices 104 coupled to a person 1110. For example, the target devices 104 may be disposed on the shoulders of the person 1110, as depicted in the example of FIG. 11. Alternatively, in some embodiments, the target devices may be coupled to a head of the person 1110 and/or the arms or wrists of the person 1110.

In some embodiments, the RF co-localization system 1100 also includes target devices 104 coupled to machinery 1120. It should be appreciated that while the machinery 1120 of the example of FIG. 11 is depicted as manufacturing equipment, that machinery 1120 could be any other automated equipment that could cause harm to a person (e.g., a robotic arm, an AGV, manufacturing equipment, equipment associated with a production line, a conveyor belt, etc.).

In some embodiments, the controller may be configured to determine an operating volume of the machinery. In some embodiments, the controller may be configured to determine the operating volume of the machinery 1120 using positions of target devices positioned at corners of the operating volume in three-dimensional space. Alternatively, in some embodiments, the controller may be configured to determine the operating volume of the machinery 1120 using positions of target devices positioned at corners of a two-dimensional area around the operating volume, such that the controller is configured to “extrude” the operating volume in three-dimensional space using the two-dimensional area defined by the target devices. In some embodiments, the determination of the operating volume may be performed prior to usage of the RF co-localization system 1100 (e.g., the target devices used to determine the operating volume may be removed after the operating volume is determined). In some embodiments, the determination of the operating volume may be performed during usage of the RF co-localization system 1100.

In some embodiments, the controller may be configured to determine whether the person 1110 is positioned within the operating volume of the machinery 1120 by determining whether an operating volume of the person 1110 overlaps with the operating volume of the machinery 1120. For example, the controller may be configured to determine the position of the person 1110 by controlling the interrogator system 101 to transmit RF signals to the target devices 104 coupled to the person, controlling the interrogator system 101 to receive responsive RF signals from the target devices 104, and determining the positions of the target devices 104 using the responsive RF signals (e.g., as described in connection with FIG. 14 herein). Thereafter, the controller may be configured to determine the operating volume of the person 1110 using the positions of the target devices 104. For example, the operating volume of the person 1110 may be determined as a volume around the positions of the target devices 104 in which the person 1110 is likely to interact with other objects (e.g., within a sphere having a radius equal to an arm-distance of an average person). In some embodiments, the controller may then be configured to determine whether the operating volume of the person 1110 overlaps with the operating volume of the machinery 1120 to determine whether the person 1110 has entered the operating volume of the machinery 1120.

In some embodiments, the controller may be configured to generate an alert when the person 1110 enters an operating volume of the machinery 1120 in order to prevent unsafe interaction between the person 1110 and the machinery 1120. An alert may be of any suitable type. For example, an alert may be a visual alert (e.g., a light, a strobe, a message on a screen of a computing device, etc.), an audible alert (e.g., a loud sound and/or verbal warning), a tactile alert (e.g., a phone or other device on the person vibrates to alert the person that they are within the operating volume of the machinery), or any other suitable type of alert, as aspects of the technology described herein are not limited in this respect. One or more different types of alerts may be generated at the same time, in some embodiments. For example, any two or all three of the above-described example types of alerts (i.e., visual, audible, and tactile alerts) may be generated when it is determined that the person is positioned within the operating volume of the machinery.

In some embodiments, the controller may be configured to change an operation mode of the machinery 1120 when the person 1110 enters the operating volume of the machinery 1120. For example, the controller may be configured to cause the machinery 1120 to stop operation (e.g., to stop moving any movable parts, to return to an “off” position) of the machinery 1120 when the person 1110 enters the operating volume of the machinery 1120. Alternatively, the controller may be configured to cause the machinery 1120 to operate at a reduced speed (e.g., one-half speed, one-quarter speed) when the person 1110 enters the operating volume of the machinery 1120.

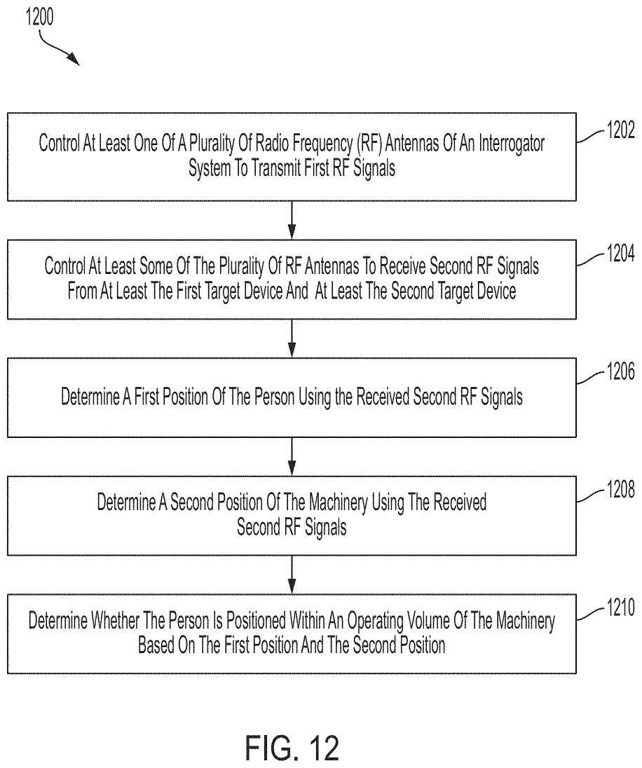

FIG. 12 is a flowchart of an illustrative process 1200 for determining whether a person has entered an operating volume associated with machinery, in accordance with some embodiments of the technology described herein. Process 1000 may be executed by any suitable localization system described herein including, for example, system 100 described with reference to FIG. 1A, RF co-localization system 200 described with reference to FIG. 2, RF co-localization system 400 described with reference to FIG. 4, RF co-localization system 600 described with reference to FIG. 6, RF co-localization system 900 described with reference to FIG. 9, and/or RF co-localization system 1300 described with reference to FIG. 13.

Process 1200 may begin at act 1202, where a controller of an RF co-localization system may control at least one of a plurality of RF antennas of an interrogator system to transmit first RF signals. The interrogator system may transmit the first RF signals to at least a first target device (e.g., target device 104 as described in connection with FIGS. 1A, 1B, 1C, and 14) coupled to a person and at least a second target device (e.g., target device 104 as described in connection with FIGS. 1A, 1B, 1C, and 14) coupled to machinery. In some embodiments, the first RF signal may be of any suitable type and, for example, may be a linear frequency modulated RF signal or any other suitable type of RF signal including any of the types of signals described herein. The first RF signal transmitted at act 1002 may have any suitable center frequency. For example, the center frequency may be any frequency in the range of 50-70 GHz (e.g., 60 GHz) or any frequency in the range of 4-6 GHz (e.g., 5 GHz). The first RF signal transmitted at act 1002 may be circularly polarized in the clockwise or counterclockwise direction.

After act 1202, process 1200 may proceed to act 1204. At act 1204, the controller may control at least some of the plurality of RF antennas of the interrogator system to receive second RF signals from at least the first target device coupled to the person and at least the second target device coupled to the machinery. The second RF signals may be generated by target devices, including the first and second target devices, within the environment of the interrogator system in response to receiving the first RF signal transmitted by the interrogator system. The responsive second RF signal may be a transformed version of the transmitted first RF signal. The target devices may generate the responsive RF signals by receiving and transforming the transmitted RF signal according to any of the techniques described herein.

After act 1204, process 1200 may proceed to act 1206. At act 1206, the controller may determine a first position of the person using the received second RF signals. In some embodiments, the controller may determine the position of the person in a common reference frame associated with the interrogator system. In some embodiments, the controller may determine the position of the person by first determining an estimate of the distances between at least some of the plurality of RF antennas and at least the first target device coupled to the person. The controller may determine the estimate of the distances between at least some of the plurality of RF antennas and at least the first target device coupled to the person in any suitable way. For example, the controller may use the process 1400 as described in connection with FIG. 14 herein to determine the estimate of the distances and the position of the person within the common reference frame.

After act 1206, process 1200 may proceed to act 1208. At act 1208, the controller may determine a second position of the machinery using the received second RF signals. In some embodiments, the controller may determine the position of the machinery in a common reference frame associated with the interrogator system. In some embodiments, the controller may determine the position of the machinery by first determining an estimate of the distances between at least some of the plurality of RF antennas and at least the second target device coupled to the machinery. The controller may determine the estimate of the distances between at least some of the plurality of RF antennas and at least the second target device coupled to the machinery in any suitable way. For example, the controller may use the process 1400 as described in connection with FIG. 14 herein to determine the estimate of the distances and the position of the machinery within the common reference frame.

In some embodiments, the controller may be configured to determine the operating volume of the machinery 1120 using positions of target devices positioned at corners of the operating volume in three-dimensional space. Alternatively, in some embodiments, the controller may be configured to determine the operating volume of the machinery 1120 using positions of target devices positioned at corners of a two-dimensional area around the operating volume, such that the controller is configured to “extrude” the operating volume in three-dimensional space using the two-dimensional area defined by the target devices.

In some embodiments, the determination of the operating volume may be performed prior to the start of process 1200. In some embodiments, the determination of the operating volume may be performed during process 1200. The controller may determine a position of the operating volume in the common reference frame using the second position of the machinery. For example, the controller may use a transformation to determine positions of edges and/or corners of the operating volume in the common reference frame. In some embodiments, at least the second target device may be positioned, for example, at an origin point of the operating volume such that the positions of edges and/or corners are determined to be around the position of at least the second target device.

After act 1208, process 1200 may proceed to act 1210. At act 1210, the controller may determine whether the person is positioned within an operating volume of the machinery based on the first position of the person and the second position of the person. The controller may be configured to determine whether the person is positioned within the operating volume of the machinery by determining whether an operating volume of the person overlaps with the operating volume of the machinery. For example, the operating volume of the person may be determined as a volume around the first position of at least the first target device in which the person is likely to interact with other objects (e.g., within a sphere having a radius equal to an arm-distance of an average person). In some embodiments, the controller may then be configured to determine whether the operating volume of the person overlaps with the operating volume of the machinery to determine whether the person has entered the operating volume of the machinery.

In some embodiments, after performing process 1200, the controller may generate an alert when the person enters an operating volume of the machinery in order to prevent unsafe interaction between the person and the machinery. An alert may be of any suitable type as described herein. Alternatively or additionally, in some embodiments, the controller may change an operation mode of the machinery when the person enters the operating volume of the machinery. For example, the controller may cause the machinery to stop operation (e.g., to stop moving any movable parts, to return to an “off” position) or to operate at a reduced speed (e.g., one-half speed, one-quarter speed) when the person enters the operating volume of the machinery.

FIG. 13 shows an example of an RF co-localization system 1300 configured to use RF localization to safely permit the operation of a robotic arm and a movable platform in the presence of a person, in accordance with some embodiments of the technology described herein. The RF co-localization system 1300 includes an interrogator system 101 (e.g., interrogator system 101 as described in connection with FIGS. 1A, 1B, 1C, and 14) disposed above (e.g., coupled to the ceiling) an environment in which machinery and people are present. The RF co-localization system 1300 includes a robotic arm 210, a movable platform 220, and a person 1110. It should be appreciated that any number and combinations of robotic arms 210, movable platforms 220, and people 1110 may be present in the environment, as aspects of this disclosure are not so limited.

In some embodiments, at least one target device 104 is coupled to the robotic arm 210 and/or the robot platform supporting the robotic arm 210 to enable localization of the robotic arm 210 by the interrogator system 101. The robotic arm 210 may be stationary or movable (e.g., either manually or autonomously movable). The interrogator system 101 may determine the position of the robotic arm 210 and/or generate commands to control movement of the robotic arm 210 in any suitable manner, including as described in connection with FIGS. 2-10 herein.

In some embodiments, at least one target device 104 is coupled to the movable platform 220 to enable localization of the movable platform 220 by the interrogator system 101. The interrogator system 101 may determine the position of the movable platform 220 in any suitable manner, including as described in connection with FIGS. 2-10 herein.

In some embodiments, the movable platform 220 may be an autonomous movable platform (e.g., an AGV). The movable platform 220 may be associated with a charge zone 1306. When the movable platform 220 is located within the charge zone 1306, the movable platform may be considered to be inoperative while electrically charging.

In some embodiments, target devices 104 may be disposed on the body of the person 1110 to enable localization of the person 1110. For example, the target devices 104 may be disposed on the shoulders of the person 1110, as depicted in the example of FIG. 13. Alternatively, in some embodiments, the target devices may be coupled to a head of the person 1110 and/or the arms or wrists of the person 1110. The interrogator system 101 may determine the position of the movable platform 220 in any suitable manner, including as described in connection with FIGS. 11-12 herein.

In some embodiments, a controller communicatively coupled to the interrogator system 101 may be configured to determine regions of the environment, the regions being coupled to an operational mode of devices within the environment. For example, and as depicted in the example of FIG. 13, the controller may determine a danger zone 1302, a warning zone 1303, and a safety zone 1304. The controller may be configured to change an operational mode of devices within the environment depending upon a position of the person 1110 within one of these three zones. It should be appreciated that while the example of FIG. 13 includes three zones associated with three modes of operation, that aspects of the technology are not so limited. In some embodiments there may be more than three or less than three zones and/or operational modes.

In some embodiments, when the interrogator system 101 determines that the person is positioned within the danger zone 1302, the controller may be configured to cause devices within the environment to stop operation. For example, the controller may be configured to cause the robotic arm 210 to stop performing a task and enter a pre-defined “safe” position and remain in said safe position as long as the interrogator system 101 determines that the person is positioned within the danger zone 1302. As another example, the controller may be configured to cause the movable platform 220 to return to, and remain within, the charge zone 1306 when the interrogator system 101 determines that the person is positioned within the danger zone 1302.

In some embodiments, when the interrogator system 101 determines that the person is positioned within the warning zone 1303, the controller may be configured to cause devices within the environment to slow or alter their operation. For example, the controller may be configured to cause the robotic arm 210 to perform a task at a reduced speed (e.g., at one-half speed, at one-quarter speed) relative to the robotic arm's normal speed of operation. As another example, the controller may be configured to cause the movable platform 220 to autonomously move within the environment at a reduced speed (e.g., at one-half speed, at one-quarter speed) relative to the movable platform's normal speed of movement.

In some embodiments, when the interrogator system 101 determines that the person is positioned within the safety zone 1304, the controller may be configured to cause devices within the environment to operate normally. For example, the controller may be configured to cause the robotic arm 210 to perform a task at the robotic arm's normal speed. As another example, the controller may be configured to cause the movable platform 220 to autonomously move within the environment at the movable platform's normal speed of movement.

In some embodiments, and as an example of operation of the system 1300, the system 1300 may begin operation with the person 1110 positioned within the danger zone 1302. Then, the person 1110 may change their position to be within the warning zone 1303. Upon detecting the person's change in position, the movable platform 220 may move at a reduced speed to be within reach of the robotic arm 210. The robotic arm 210 may then perform a task, at a reduced speed, with respect to an object supported by the movable platform. If the person 1110 returns to the danger zone 1302 during this time, the robotic arm 210 may be commanded to return to a safe position and the movable platform 220 may be commanded to return to the charge zone 1306 as long as the person is positioned within the danger zone 1302. If the person 1110 moves to the safety zone 1304, the robotic arm 210 may be commanded to perform a task at normal speed, and the movable platform 220 may be commanded to move within the environment at its normal speed of movement.

Having thus described several aspects of at least one embodiment of this technology, it is to be appreciated that various alterations, modifications, and improvements will readily occur to those skilled in the art.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more processors, perform methods that implement the various embodiments of the present disclosure described above. The computer-readable medium or media may be transportable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, examples of which are provided herein including with reference to FIGS. 10, 12, and 14. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately” and “about” may be used to mean within ±20% of a target value in some embodiments, within ±10% of a target value in some embodiments, within ±5% of a target value in some embodiments, within ±2% of a target value in some embodiments, within ±1% in some embodiments. The terms “approximately” and “about” may include the target value.

What is claimed is:

1. A system, comprising:
a plurality of target devices, each of the plurality of target devices being configured to transmit and receive radio-frequency (RF) signals, the plurality of target devices comprising:
at least a first target device for coupling to a movable platform configured to support an object with respect to which a robotic arm is to perform a task;
an interrogator system comprising a plurality of RF antennas, each of the plurality of RF antennas being configured to transmit RF signals to the plurality of target devices and/or receive RF signals from the plurality of target devices; and
a controller configured to, when at least the first target device is coupled to the movable platform:
control at least one of the plurality of RF antennas to transmit one or more first RF signals to at least the first target device;
control at least some of the plurality of RF antennas to receive second RF signals from at least the first target device;
determine a position of the movable platform using the received second RF signals; and
determine, using the position of the movable platform, a target position to which to move an end effector of the robotic arm in order to perform the task with respect to the object.

2. The system of claim 1, wherein at least the first target device is configured to generate and transmit the second RF signals in response to receiving the one or more first RF signals from the interrogator system.

3. The system of claim 1, wherein:
determining the position of the movable platform comprises:
determining a position of at least the first target device using the received second RF signals;
determining, using the received second RF signals, distances between the at least some of the plurality of RF antennas, distances between the at least some of the plurality of antennas and at least the first target device; and
determining the position of at least the first target device using the determined distances and trilateration.

4. The system of claim 3,
wherein at least the first target device comprises two target devices for coupling to the movable platform,
wherein determining the position of the movable platform comprises determining positions of each of the two target devices within a common reference frame associated with the interrogator system, and
wherein determining the target position comprises:
determining, using the positions of the two target devices, a first transformation between a reference frame associated with the movable platform and the common reference frame associated with the interrogator system;
determining a position of the object within the common reference frame associated with the interrogator system using the first transformation; and
determining the target position to which to move the end effector of the robotic arm using the position of the object.

5. The system of claim 1,
wherein at least the first target device comprises two target devices for coupling to the movable platform, and
wherein determining the position of the movable platform comprises:
determining, using the received second RF signals, a position of each of the two target devices coupled to the movable platform; and
determining the position of the movable platform using the positions of each of the two target devices.

6. The system of claim 4,
wherein the plurality of target devices further comprises at least a second target device for coupling to the robotic arm or a robot platform that supports the robotic arm; and
wherein the controller is further configured to, when at least the second target device is coupled to the robotic arm or the robot platform:
control the at least some of the plurality of RF antennas to receive third RF signals from at least the second target device, wherein at least the second target device is configured to generate and transmit the third RF signals in response to receiving the first RF signals from the interrogator system,
determine a position of at least the second target device using the received third RF signals, and
determine, using the position of at least the second target device, a current position of the end effector of the robotic arm within the common reference frame.

7. The system of claim 6, wherein determining the position of at least the second target device comprises determining the position of at least the second target device in the common reference frame associated with the interrogator system.

8. The system of claim 7, wherein the controller is further configured to determine, using the position of at least the second target device, a second transformation between a robot platform reference frame and the common reference frame associated with the interrogator system.

9. The system of claim 8, wherein determining the second transformation comprises:
moving the end effector to at least three different non-collinear positions;
determining the at least three positions within the common reference frame by using the interrogator system;
determining the at least three positions within the robot platform reference frame by accessing information indicative of the at least three positions within the robot platform reference frame; and
determining the second transformation by determining a homogeneous transformation matrix using the at least three positions within the common reference frame and using the at least three positions within the robot platform reference frame.

10. The system of claim 8, wherein the controller is further configured to determine, using the current position of the end effector within the common reference frame, the target position of the end effector within the common reference frame, and the second transformation, a travel vector for the end effector, the travel vector being between a current position of the end effector within the robot platform reference frame and a target position of the end effector within the robot platform reference frame.

11. The system of claim 6,
wherein at least the second target device comprises a target device for coupling to the end effector, and
wherein determining the current position of the end effector comprises determining, using the received third RF signals, a position of the target device coupled to the end effector within the common reference frame associated with the interrogator system.

12. The system of claim 6,
wherein at least the second target device comprises two target devices for coupling to the robot platform, and
wherein determining the current position of the end effector comprises:
determining, using the received third RF signals, positions of the two target devices to obtain target device positions;
determining, using the target device positions, a third transformation between a robot platform reference frame and a common reference frame associated with the interrogator system;
determining a current position of the end effector within the robot platform reference frame by accessing information indicative of the position of the end effector within the robot platform reference frame; and
applying the third transformation to the determined current position of the end effector within the robot platform reference frame to determine a current position of the end effector within the common reference frame.

13. The system of claim 1, wherein the controller is further configured to generate a command to cause the robotic arm to move the end effector to the target position in order to perform the task with respect to the object.

14. The system of claim 13, wherein the task comprises one of: picking up the object from the movable platform, placing the object on the movable platform, applying a tool to alter an aspect of the object, or using a sensing device to determine information about the object.

15. The system of claim 8, wherein determining the target position comprises determining the target position while the movable platform is in motion by iteratively performing acts of:
(A) determining, using the second RF signals, the position of the movable platform and the current position of the end effector within the common reference frame;
(B) determining, using the first transformation and the position of the movable platform, the position of the object within the common reference frame;
(C) determining, using the position of the object, the target position within the common reference frame;
(D) determining, using the current position of the end effector within the common reference frame, the target position of the end effector within the common reference frame, and the second transformation, a travel vector for the end effector, the travel vector being between a current position of the end effector within the robot platform reference frame and a target position of the end effector within the robot platform reference frame; and
(E) generating a command to cause the robotic arm to move to the target position.

16. A method performed by a controller part of a system, the system comprising: (i) the controller, (ii) a plurality of target devices comprising at least a first target device for coupling to a movable platform configured to support an object with respect to which a robotic arm is to perform a task, and (iii) an interrogator system comprising a plurality of RF antennas, each of the plurality of RF antennas being configured to transmit RF signals to the plurality of target devices and/or receive RF signals from the plurality of target devices, the method comprising:
when at least the first target device is coupled to the movable platform, using the controller to perform:
controlling at least one of the plurality of RF antennas to transmit one or more first RF signals to at least the first target device;
controlling at least some of the plurality of RF antennas to receive second RF signals from at least the first target device;
determining a position of the movable platform using the received second RF signals; and
determining, using the position of the movable platform, a target position to which to move an end effector of the robotic arm in order to perform the task with respect to the object.

17. The method of claim 16, wherein determining the position of the movable platform comprises:
determining a position of at least the first target device using the received second RF signals;
determining, using the received second RF signals, distances between the at least some of the plurality of RF antennas, distances between the at least some of the plurality of antennas and at least the first target device; and
determining the position of at least the first target device using the determined distances and trilateration.

18. The method of claim 17,
wherein the plurality of target devices further comprises at least a second target device for coupling to the robotic arm or a robot platform that supports the robotic arm; and
wherein the method further comprises using the controller to, when at least the second target device is coupled to the robotic arm or the robot platform:
control the at least some of the plurality of RF antennas to receive third RF signals from at least the second target device, wherein at least the second target device is configured to generate and transmit the third RF signals in response to receiving the first RF signals from the interrogator system,
determine a position of at least the second target device using the received third RF signals, and
determine, using the position of at least the second target device, a current position of the end effector of the robotic arm within the common reference frame.

19. The method of claim 18, wherein the method further comprises using the controller to:
determine, using the position of at least the second target device, a second transformation between a robot platform reference frame and the common reference frame associated with the interrogator system; and
to determine, using the current position of the end effector within the common reference frame, the target position of the end effector within the common reference frame, and the second transformation, a travel vector for the end effector, the travel vector being between a current position of the end effector within the robot platform reference frame and a target position of the end effector within the robot platform reference frame.

20. A system, comprising:
a plurality of target devices, each of the plurality of target devices configured to transmit and receive radio-frequency (RF) signals, the plurality of target devices comprising:
at least a first target device for coupling to a person; and
at least a second target device for coupling to machinery;
an interrogator system comprising a plurality of RF antennas, each of the plurality of RF antennas being configured to transmit RF signals to the plurality of target devices and/or receive RF signals from the plurality of target devices; and
a controller configured to, when at least the first target device is coupled to the person and at least the second target device is coupled to the machinery:
control at least one of the plurality of RF antennas to transmit first RF signals;
control at least some of the plurality of RF antennas to receive second RF signals from at least the first target device and at least the second target device;
determine a first position of the person using the received second RF signals;
determine a second position of the machinery using the received second RF signals; and
determine whether the person is positioned within an operating volume of the machinery using the first position and the second position.
